(19) United States
(12) Patent Application Publication
(10) Pub. No.: US 2022/0318679 A1
(43) Pub. Date: Oct. 6, 2022

(54) MULTI-FACETED BOT SYSTEM AND METHOD THEREOF

(71) Applicant: Jio Platforms Limited, Ahmedabad (IN)

(72) Inventors: Dhaval JETHWA, Maharashtra (IN); Shreyas RAMANATHAN, Maharashtra (IN); Abhishek FARKADE, Maharashtra (IN); Sachin DEV, Maharashtra (IN); Arijay CHAUDHRY, Maharashtra (IN); Gaurav DUGGAL, Telangana (IN)

(73) Assignee: Jio Platforms Limited, Ahmedabad (IN)

(21) Appl. No.: 17/710,385

(22) Filed: Mar. 31, 2022

(30) Foreign Application Priority Data
Mar. 31, 2021 (IN) 202121014970

(51) Int. Cl. G06N 20/00

(52) U.S. Cl. CPC G06N 20/00

(57) ABSTRACT

The present disclosure relates to a system and method for generating an executable multi-faceted specific to an entity. In an exemplary implementation, the proposed system receives a knowledgebase comprising a set of potential queries associated with the entity, and receives responses that can be switched to a video form, an audio form or a textual form corresponding to the potential queries based on any or a combination of user preference, network conditions and user device features. The system processes, through a machine learning model, training data comprising the set of potential queries, the video frame responses, and the intent mapped to each potential query to generate a trained model, based on which a prediction engine is configured to process an end-user query and predict an intent associated with the end-user query, and facilitate response to the end-user query based on video frame response that is mapped with the predicted intent.

### RESERVATION OF RIGHTS

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to facilitating generation of response to a user query. More particularly, the present disclosure relates to a system and method for facilitating generation of one or more automated textual, audio or visual responses to a user query based on a machine learning based architecture.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Alongside, processing of the computing devices is hugely improved over the years such that the consumers have now option/s to select from multiple features such as voice calling, messaging, video calling and many other value added services initiated from native dialler applications. One of said multiple features in the smartphone device that has evolved is voice/video or any combination of multimedia call. The device has a user interface which typically includes a display with or without keypad including a set of alpha-numeric (ITU-T type) keys that may be real keys or virtual keys. Existing Bots are enabled with Text BOTs and customers are accustomed to interact with BOT using text Message for both queries as well as response.

This experience is not always the best experience. A customer survey showed that customers prefer to ask questions verbally and get an answer in a visual mode, especially in the safety of privacy. Customers with the existing bots do not have the power of interacting verbally and getting response in the form of a video. Also, if customer experiences poor network, video streaming has a poor experience and there is no technology to audio or a textual based interaction in the existing bots. Further, existing bots are not enabled with automatic selection of lower-bandwidth interaction or choose a mode of BOT interaction. There is no personalized preference for customer Interaction and no network strength-based smooth customer interaction in the existing bots.

There is therefore a need in the art to provide a system and a method that can facilitate self-generation of entity/user specific bots that can be customized with one or more entity-specific automated visual responses to user queries that can be switched back and forth to audio or textual form of interaction based on user preference or based on network connection for enhanced user experience.

### OBJECTS OF THE PRESENT DISCLOSURE

Some of the objects of the present disclosure, which at least one embodiment herein satisfies are as listed herein below.

It is an object of the present disclosure to enable a 3-in-one Chat, Audio and Video service integration to provide seamless customer experience.

It is an object of the present disclosure to ensure concurrency of services for chat services working simultaneously with Audio or Video Services.

It is an object of the present disclosure that can be upgraded or downgraded from one mode to the other based on request by the service provider or customer.

It is an object of the present disclosure to facilitate a bot Integrated Telephony IVR System, over Native Dialer and OTT BOTs with Chat—Audio and Video Bot capability.

It is an object of the present disclosure to facilitate any or a combination of Video, Voice and Text BOT Integration with In-bound or Out-bound Telephony IVR System.

It is an object of the present disclosure to facilitate Integrated User authentication to provide secure access to personalized information.

It is an object of the present disclosure to facilitate Unified Customer Conversation history across all mediums including OTT, IVR and Web.

It is an object of the present disclosure to facilitate multilingual capabilities with on-the-fly language change option.

It is an object of the present disclosure to enable SDK for OTT integration.

It is an object of the present disclosure to facilitate Face Recognition and Sentiment Recognition integration.

### SUMMARY

This section is provided to introduce certain objects and aspects of the present invention in a simplified form that are further described below in the detailed description. This summary is not intended to identify the key features or the scope of the claimed subject matter.

In an aspect, the proposed system is configured to generate an executable bot application specific to an entity, where the system comprises a processor that executes a set of executable instructions that are stored in a memory, upon which execution, the processor causes the system to receive, by a bot maker engine, a first set of data packets corresponding to a user query of the user, and receive, from a database coupled to a server, a knowledgebase may include a set of expressions associated with one or more potential intents corresponding to the user queries; extract, by a bot maker engine, a set of attributes corresponding to form of the user query, where the form of the user query is selected from any or a combination of a textual form, an audio form, and a video form; process, through an ML engine, training data comprising the user query, one or more responses corresponding to the user query, and the one or more potential intents that may be mapped to each of the user queries, and where the ML engine may identify a primary potential intent among the one or more potential intents for the user query by calculating probability for each potential intent among the one or more potential intents for the set of expressions associated with the user query to generate a trained model; predict, using the ML engine, the one or more responses in any or a combination of the textual form, the audio form, and video form based on the extracted set of attributes and the generated trained model; and convert, using the ML engine, the one or more responses to any or a combination of textual form, audio form, and video form from any or a combination of textual form, the audio form, and the video form based on any user and system requirement.

The present disclosure further provides for a method for generating an executable bot application specific to an entity, where the method comprises the steps of: receiving, by a bot maker engine, a first set of data packets corresponding to a user query of the user, and receive, from a database coupled to a server, a knowledgebase comprising a set of expressions associated with one or more potential intents corresponding to the user queries; extracting, by a bot maker engine, a set of attributes corresponding to form of the user query, where the form of the user query may be selected from any or a combination of a textual form, an audio form, and a video form; processing, through an ML engine, training data comprising the user query, one or more responses corresponding to the user query, and the one or more potential intents that are mapped to each of the user queries, and where the ML engine identifies a primary potential intent among the one or more potential intents for the user query by calculating probability for each potential intent among the one or more potential intents for the set of expressions associated with the user query to generate a trained model; predicting, using the ML engine, the one or more responses in any or combination of the textual form, the audio form, and video form based on the extracted set of attributes and the generated trained model; and converting, using the ML engine, the one or more responses to any or a combination of textual form, audio form, and video form from any or a combination of textual form, the audio form, and the video form based on any user and system requirement.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture in which or with which the system of the present disclosure can be implemented for an executable multi-faceted bot, in accordance with an embodiment of the present disclosure.

FIG. 2 illustrates an exemplary representation of system or a centralized server for an executable multi-faceted bot, in accordance with an embodiment of the present disclosure.

FIG. 3 illustrates exemplary method flow diagram depicting a method for facilitating generation of an entity-specific multi-faceted bot, in accordance with an embodiment of the present disclosure.

FIG. 4 illustrates an exemplary block flow diagram depicting components of the system architecture involved in generation of an entity-specific multi-faceted bot, in accordance with an embodiment of the present disclosure.

FIG. 5A-5B illustrate representations for exemplary overviews of the system architecture and its implementation, in accordance with an embodiment of the present disclosure.

FIG. 6. Illustrates an exemplary flow diagram representation) of a method for generating the multi-faceted bot, in accordance with an embodiment of the present disclosure.

FIG. 7 illustrates an exemplary flow diagram depicting bot-as-a-service platform in accordance with an embodiment of the present disclosure.

FIGS. 8A-8F illustrate exemplary representations of architecture of training using authoring Portal and bot-Maker module, in accordance with an embodiment of the present disclosure.

FIG. 9 illustrates an exemplary representation of an architecture of the Native Dialler flow, in accordance with embodiments of the present disclosure.

FIGS. 10A-10X illustrate representations of the exemplary working of the system and method, in accordance with embodiments of the present disclosure.

FIG. 11 refers to the exemplary computer system in which or with which embodiments of the present invention can be utilized, in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The present invention provides a robust and effective solution to an entity or an organization by enabling them to implement a system for automatic switching between visual responses, audio responses and textual responses without getting help from an expert/professional assistance as well as ability to customize responses to any queries that may be asked by users using their devices, wherein the queries may be related to one or more aspects of operational services/goods of the entity. Particularly, the system and method may empower a user to choose between any mode of interaction, the modes being provision of a visual interaction, audio interaction or a textual based interaction and a combination thereof based on a machine learning architecture, which allows the entity or organizations to customize the information and responses as per the user requirements or based on network and peripheral device connections. Thus, the system and method of the present disclosure may be beneficial for both entities and users.

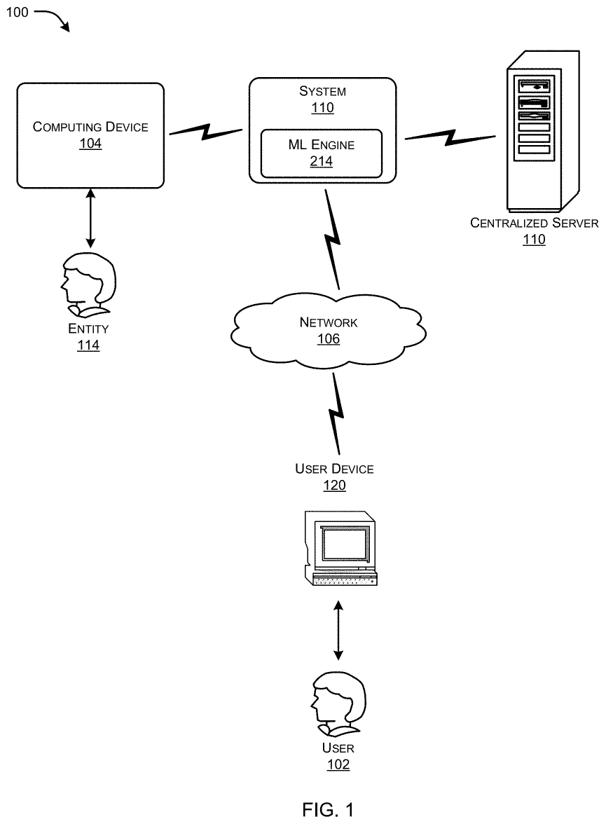

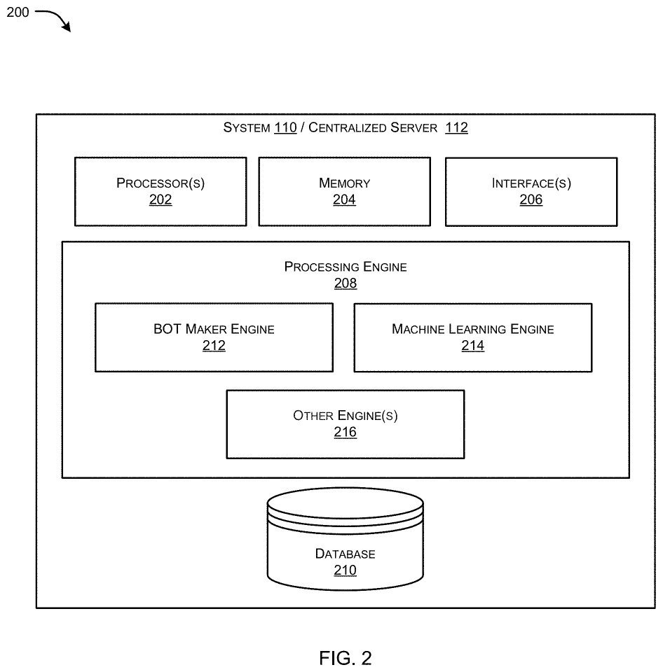

Referring to FIG. 1 that illustrates an exemplary network architecture (100) in which or with which system (110) of the present disclosure can be implemented, in accordance with an embodiment of the present disclosure. As illustrated in FIG. 1, by way of example and not by not limitation, the exemplary architecture (100) may include a user (102) associated with a user computing device (120) (also referred to as user device (120)), at least a network 106, at least a centralized server 112 and at least a second computing device (104) associated with an entity (114). More specifically, the exemplary architecture (100) includes a system (110) equipped with a machine learning (ML) engine (216) for facilitating managing user query through at least three modes of interactions on the bot from the user computing device (120). The system (110) may include a database (210) that may store a knowledgebase having a set of responses to a set of user queries associated with the entity (114) and a plurality of information services associated with the user (102) and the query generated by the user. The user device (120) may be communicably coupled to the centralized server (112) through the network (106) to facilitate communication therewith. As an example and not by way of limitation, the computing device (104) may be operatively coupled to the centralised server (112) through the network (106) and may be associated with the entity (114) configured to generate the set of responses and record respective potential video frame, audio or textual responses for the set of user queries. The system may include a bot maker engine (212) (refer to FIG. 2) that can receive a first set of data packets corresponding to a user query of a user, and also receive, from a database coupled to a server, a knowledgebase comprising a set of expressions associated with one or more potential intents corresponding to the user queries. The bot maker engine (212) may also extract a set of attributes corresponding to form of the user query, wherein the form of the user query may be selected from any or a combination of a textual form, an audio form, and a video form, augmented reality/virtual Reality form but not limited to it. A machine learning (ML) engine (214) may be configured to training data that may include the user query, one or more responses corresponding to the user query, and the one or more potential intents that may be mapped to each of the user queries. The ML engine (214) may then identify a primary potential intent among the one or more potential intents for the user query by calculating probability for each potential intent among the one or more potential intents for the set of expressions associated with the user query to generate a trained model and then predict, using the ML engine (214), the one or more responses in any or a combination of said textual form, said audio form, video form, or Augmented reality/Virtual Reality form based on the extracted set of attributes and the generated trained model. The ML engine (214) further may convert the one or more responses to any or a combination of textual form, audio form, and video form, Augmented reality/Virtual Reality form from any or a combination of textual form, the audio form, and the video form or Augmented reality/Virtual Reality form based on any user and system requirement.

In an embodiment, the database coupled to the centralised server (112) (also referred to as the server (112)) may be configured to store the users, bots, user queries, video forms, audio forms and textual messages, or augmented reality/Virtual Reality form associated with predefined topic with a time stamp.

In an embodiment, the bot maker engine may extracts from the server (112) a second set of data packets to initialize the multi-faceted bot, the second set of data packets pertaining to information that may include the one or more potential intents, one or more video forms, and a set of trending queries.

In an embodiment, a user may be identified, verified and then authorized to access the system (110). In an embodiment the one or more responses may be initiated once an authorized user generates the user query, and the one or more responses corresponding to the user query that may be mapped with the one or more potential intents that may be transmitted in real-time in the form of a third set of data packets to the user computing device (120) from server side of the multi-faceted bot.

In an embodiment, the ML engine may be configured to enable the user to switch to any the textual, the audio form and the video form from a current form to initiate the user query.

In an embodiment, the ML engine is configured to enable the user to switch to any the textual, the audio form and the video form from a current form of response provided by the system.

In an embodiment, the client side of the multi-faceted bot may be represented in the form of any or a combination of an animated character, a personality character, or an actual representation of the entity character.

In an embodiment, the responses pertaining to the audio form and the video form are manually recorded using a recording device, and where the responses pertaining to the textual form, the audio form and the video form may be stored in the database coupled to the server (112).

In an embodiment, the ML engine (214) may pre-process the knowledgebase through a prediction engine for any or a combination of data cleansing, data correction, synonym formation, proper noun extraction, white space removal, stemming of words, punctuation removal, feature extraction, and special character removal, where the data may pertain to the set of potential queries associated with the entity and corresponding any or a combination of textual form, audio form and video form responses.

In an embodiment, the ML model may include a long-term short-term memory (LSTM) based model having culmination of logistic regression model and neural network based bi-directional LSTM cells.

In an embodiment, the knowledgebase may be used to train LSTM neural net using categorical cross entropy as loss function and an optimizer, where the ML model may facilitate supervised learning.

In an embodiment, each layer of the LSTM neural net may extract information during the training to minimize loss function and to retrain one or more weights of the respective layer.

In an embodiment, the lowest layer of the LSTM neural net may be passed to logistic regression (LR) to create sentence vectors from the set of potential queries, the sentence vectors acting as input for the LR to calculate probabilities for each intent mapped to a potential query such that the system may estimate an output including the intent with highest probability.

In an embodiment, the ML engine may be configured with an L1L2 engine coupled to the knowledgebase to create variations of a word in the training set to increase the vocabulary of the trained model, where the L1L2 engine may be configured for a user query generated in audio form.

In an embodiment, during evaluation of the output, assessment may be performed by the prediction engine based on a predetermined set of rules that screen through any or a combination of a pre-defined salutation and one or more attributes associated with the user query such that if the assessment indicate a negative response, the user query may be converted into a mathematical representation of expressions using the trained model to identify a relevant intent associated with the user query for providing the output, where the prediction may be done to estimate the predicted intent with highest probability in a manner that the any or a combination of textual, audio and video response that may be mapped with the predicted intent transmitted.

In an embodiment, the ML engine may be configured with language processing engines to receive the user query in any language and provide the response corresponding to the user query in any language.

In an embodiment, an authoring portal engine coupled to the ML engine may be configured to manage any or a combination of information associated with the users, a plurality of trained models, life cycle of each trained model of the plurality of trained models, sorting and searching the plurality of trained models, life cycle of a plurality of multi-faceted bots and generating executable instructions to invoke the multi-faceted bot among plurality of multi-faceted bots.

In an embodiment, management of the life cycle of the trained model by the authoring portal engine may be creating a model, adding expressions and one or more potential intents to the model, training the model, testing the model and publishing the model.

In an embodiment, the ML engine (214) may be configured with an event streaming module such as but not limited to a Kafka module, where the event streaming module may be configured to maintain a queue of expressions, containing information about predictions performed by the ML engine (214).

In an embodiment, the computing device (104) and/or the user device (120) may communicate with the system (110) via set of executable instructions residing on any operating system, including but not limited to, Android™, iOS™, Kai OS™ and the like. In an embodiment, computing device (104) and/or the user device (120) may include, but not limited to, any electrical, electronic, electro-mechanical or an equipment or a combination of one or more of the above devices such as mobile phone, smartphone, virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen and the like. It may be appreciated that the computing device (104) and/or the user device (120) may not be restricted to the mentioned devices and various other devices may be used. A smart computing device may be one of the appropriate systems for storing data and other private/sensitive information.

In an exemplary embodiment, a network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof.

In another exemplary embodiment, the centralized server (112) may include or comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

In an embodiment, the system (110) may include one or more processors coupled with a memory, wherein the memory may store instructions which when executed by the one or more processors may cause the system to generate a multi-faceted bot to provide responses to a user query in any visual form, audio form or textual form or in a combination thereof. FIG. 2 with reference to FIG. 1, illustrates an exemplary representation of system (110)/centralized server (112) for facilitating self-generation of an entity-specific bot through which one or more automated visual, audio, textual based responses and a combination thereof to an end-user query may be transmitted based on a machine learning based architecture, in accordance with an embodiment of the present disclosure. In an aspect, the system (110)/centralized server (112) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (206) of the system (110). The memory (206) may be configured to store one or more computer-readable instructions or routines in a non-transitory computer readable storage medium, which may be fetched and executed to create or share data packets over a network service. The memory (206) may comprise any non-transitory storage device including, for example, volatile memory such as RAM, or non-volatile memory such as EPROM, flash memory, and the like.

In an embodiment, the system (110)/centralized server (112) may include an interface(s) 204. The interface(s) 204 may comprise a variety of interfaces, for example, interfaces for data input and output devices, referred to as I/O devices, storage devices, and the like. The interface(s) 204 may facilitate communication of the system (110). The interface(s) 204 may also provide a communication pathway for one or more components of the system (110) or the centralized server (112). Examples of such components include, but are not limited to, processing engine(s) 208 and a database 210.

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110)/centralized server (112) may comprise the machine-readable storage medium storing the instructions and the processing resource to execute the instructions, or the machine-readable storage medium may be separate but accessible to the system (110)/centralized server (112) and the processing resource. In other examples, the processing engine(s) (208) may be implemented by electronic circuitry.

The processing engine (208) may include one or more engines selected from any of a bot maker engine (212), a machine learning (ML) engine (214), and other engines (216). The other engine(s) (216) may include a prediction engine, an L1L2 engine, language processing engines, an authoring portal engine, a Kafka module and the like.

In an embodiment, the bot maker engine (212) of the system (110) can receive a first set of data packets corresponding to a user query of the user, and receive, from a database (210) coupled to a server (112), a knowledgebase that may include a set of expressions associated with one or more potential intents corresponding to the user queries. The bot maker engine (212) may also extract a set of attributes corresponding to form of the user query, wherein the form of the user query may be selected from any or a combination of a textual form, an audio form, and a video form. The bot maker engine may extract from the server a second set of data packets to initialize the multi-faceted bot, where the second set of data packets may pertain to information that may include the one or more potential intents, one or more video forms, one or more audio forms and a set of trending queries.

An ML engine (214) may process training data that may include the user query, one or more responses corresponding to the user query, and the one or more potential intents that may be mapped to each of the user queries. The ML engine (214) may identify a primary potential intent among the one or more potential intents for the user query by calculating probability for each potential intent among the one or more potential intents for the set of expressions associated with the user query to generate a trained model. The ML engine (214) may further predict by using the prediction engine one or more responses in any or a combination of the textual form, the audio form, and the video form based on the extracted set of attributes and the generated trained model and convert, using the ML engine (214), the one or more responses to any or a combination of textual form, audio form, and video form from any or a combination of textual form, the audio form, and the video form based on any user and system requirement. The trained model ML model may include a long-term short-term memory (LSTM) based model having culmination of logistic regression model and neural network based bi-directional LSTM cells. The knowledgebase may be used to train LSTM neural net using categorical cross entropy as loss function and an optimizer and thus the ML model may facilitate supervised learning. Each layer of the LSTM neural net may extract information during the training to minimize loss function and to retrain one or more weights of the respective layer. The lowest layer of the LSTM neural net may be passed to logistic regression (LR) to create sentence vectors from the set of potential queries, the sentence vectors acting as input for the LR to calculate probabilities for each intent mapped to a potential query such that the system estimates an output including the intent with highest probability.

In an embodiment, a user is identified, verified and then authorized to access the system by the ML engine (214). The one or more responses may be initiated once an authorized user generates the user query, and the one or more responses corresponding to the user query mapped with the one or more potential intents may be transmitted in real-time in the form of a third set of data packets to the user computing device (120) from server side of the multi-faceted bot. The ML engine (214) may be configured to enable the user to switch to any the textual, the audio form and the video form from a current form to initiate the user query. The ML engine may be further configured to enable the user to switch to any the textual, the audio form and the video form from a current form of response provided by the system. The ML engine may be also configured with an event streaming module such as but not limited to a Kafka module. The event streaming module may maintain a queue of expressions, containing information about predictions performed by the ML engine (214).

In yet another aspect, the ML engine (214) can be configured to pre-processes the knowledgebase for any or a combination of data cleansing, data correction, synonym formation, proper noun extraction, white space removal, stemming of words, punctuation removal, feature extraction, and special character removal, wherein the data pertains to the set of potential queries associated with the entity and corresponding video frame responses.

In an embodiment, the L1L2 engine coupled to the knowledgebase to create variations of a word in the training set to increase the vocabulary of the trained model. The L1L2 engine may be further configured for a user query generated in audio form.

In an embodiment, during evaluation of the output, assessment may performed by the prediction engine based on a predetermined set of rules that screen through any or a combination of a pre-defined salutation and one or more attributes associated with the user query such that if the assessment indicates a negative response, the user query may be converted into a mathematical representation of expressions using the trained model to identify a relevant intent associated with the user query for providing the output. The prediction may be done to estimate the predicted intent with highest probability in a manner that the any or a combination of textual, audio and video response that may be mapped with the predicted intent that may be transmitted.

In an embodiment, one or more processing engines may receive the user query in any language and provide the response corresponding to the user query in any language.

In an authoring portal engine coupled to the ML engine may be configured to manage any or a combination of information associated with the users, a plurality of trained models, life cycle of each trained model of the plurality of trained models, sorting and searching the plurality of trained models, life cycle of a plurality of multi-faceted bots and generating executable instructions to invoke the multi-faceted bot among plurality of multi-faceted bots. The management of the life cycle of the trained model by the authoring portal engine may include creating a model, adding expressions and one or more potential intents to the model, training the model, testing the model and publishing the model. The database (210) coupled to the server may be configured to store the users, bots, user queries, video forms, audio forms and textual messages associated with predefined topic with a time stamp.

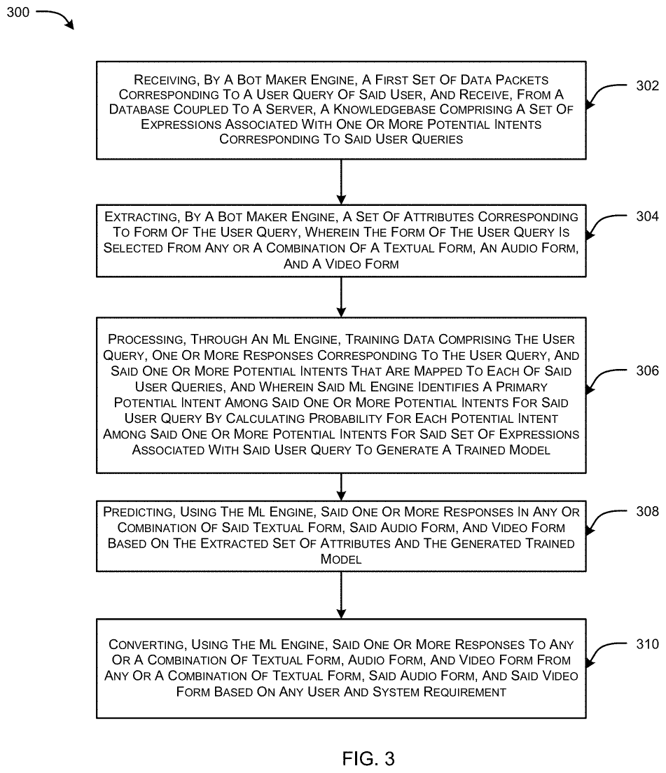

FIG. 3 illustrates exemplary method flow diagram (300) depicting a method for facilitating authorization on the bot application, in accordance with an embodiment of the present disclosure. At 302, the method may include the step of receiving, by a bot maker engine, a first set of data packets corresponding to a user query of the user, and receive, from a database coupled to a server, a knowledgebase comprising a set of expressions associated with one or more potential intents corresponding to the user queries and at 304, the method (300) may further include the step of extracting, by a bot maker engine, a set of attributes corresponding to form of the user query, the form of the user query may be selected from any or a combination of a textual form, an audio form, and a video form.

In an exemplary embodiment, the query can be in the form of Augmented reality or Virtual Reality form but not limited to the like.

Further, the method (300) may include at 306 the step of processing, through an ML engine, training data comprising the user query, one or more responses corresponding to the user query, and the one or more potential intents that may be mapped to each of the user queries. The ML engine may also identify a primary potential intent among the one or more potential intents for the user query by calculating probability for each potential intent among the one or more potential intents for the set of expressions associated with the user query to generate a trained model and at 308 the step of predicting, using the ML engine, the one or more responses in any or combination of the textual form, the audio form, and video form based on the extracted set of attributes and the generated trained model.

Furthermore, the method may include at 310, the step of converting, using the ML engine, the one or more responses to any or a combination of textual form, audio form, and video form from any or a combination of textual form, the audio form, and the video form based on any user and system requirement.

In an embodiment, the method may include the step of extracting by the bot maker engine from the server a second set of data packets to initialize the multi-faceted bot, wherein the second set of data packets pertains to information comprising of the one or more potential intents, one or more video forms, and a set of trending queries. In an embodiment, the method may include the step of enabling the user to switch to any textual, audio form and video form from a current form to initiate the user query by the ML engine. In an embodiment, the method may include the step of enabling the user to switch to any the textual, the audio form and the video form from a current form of response provided by the ML engine.

In an embodiment, the method may include the step of representing the client side of the multi-faceted bot by any or a combination of an animated character, a personality character, or an actual representation of the entity character.

In an embodiment, the method may further include the step of manually recording the responses pertaining to the audio form and the video form using a recording device, and wherein the responses pertaining to the textual form, the audio form and the video form are stored in the database coupled to the server.

In an embodiment, the method may further include the step of pre-processing by the ML engine, the knowledgebase through a prediction engine for any or a combination of data cleansing, data correction, synonym formation, proper noun extraction, white space removal, stemming of words, punctuation removal, feature extraction, and special character removal, wherein the data may pertain to the set of potential queries associated with the entity and corresponding any or a combination of textual form, audio form and video form responses.

In an embodiment, the method may further include the step of including a long-term short-term memory (LSTM) based model having culmination of logistic regression model and neural network based bi-directional LSTM cells. The knowledgebase may be used to train LSTM neural net using categorical cross entropy as loss function and an optimizer, wherein the ML model may facilitate supervised learning. Each layer of the LSTM neural net may extract information during the training to minimize loss function and to retrain one or more weights of the respective layer. The lowest layer of the LSTM neural net may be passed to logistic regression (LR) to create sentence vectors from the set of potential queries, the sentence vectors acting as input for the LR to calculate probabilities for each intent mapped to a potential query such that the method estimates an output including the intent with highest probability.

In an embodiment, the method may further include the step of creating variations of a word in the training set to increase the vocabulary of the trained model by an L1L2 engine associated with the ML engine and coupled to the knowledgebase, where the L1L2 engine may be configured for a user query generated in audio form.

In another embodiment, during evaluation of the output, the method may include the step of performing the assessment by the prediction engine based on a predetermined set of rules that screen through any or a combination of a pre-defined salutation and one or more attributes associated with the user query such that if the assessment indicates a negative response, the user query may be converted into a mathematical representation of expressions using the trained model to identify a relevant intent associated with the user query for providing the output, wherein the prediction may be done to estimate the predicted intent with highest probability in a manner that the any or a combination of textual, audio and video response that may be mapped with the predicted intent may be transmitted.

In an embodiment, the method may further include the step of receiving the user query in any language and provide the response corresponding to the user query in any language by the ML engine that may be configured with language processing engines.

In an embodiment, the method may further include the step of managing any or a combination of information associated with the users, a plurality of trained models, life cycle of each trained model of the plurality of trained models, sorting and searching the plurality of trained models, life cycle of a plurality of multi-faceted bots and generating executable instructions to invoke the multi-faceted bot among plurality of multi-faceted bots by an authoring portal engine coupled to the ML engine. The management of the life cycle of the trained model by the authoring portal engine may include the steps of creating a model, adding expressions and one or more potential intents to the model, training the model, testing the model and publishing the model.

In an embodiment, the method may further include the step of maintaining a queue of expressions, containing information about predictions performed by the ML engine with the help of the event streaming module associated with the ML engine.

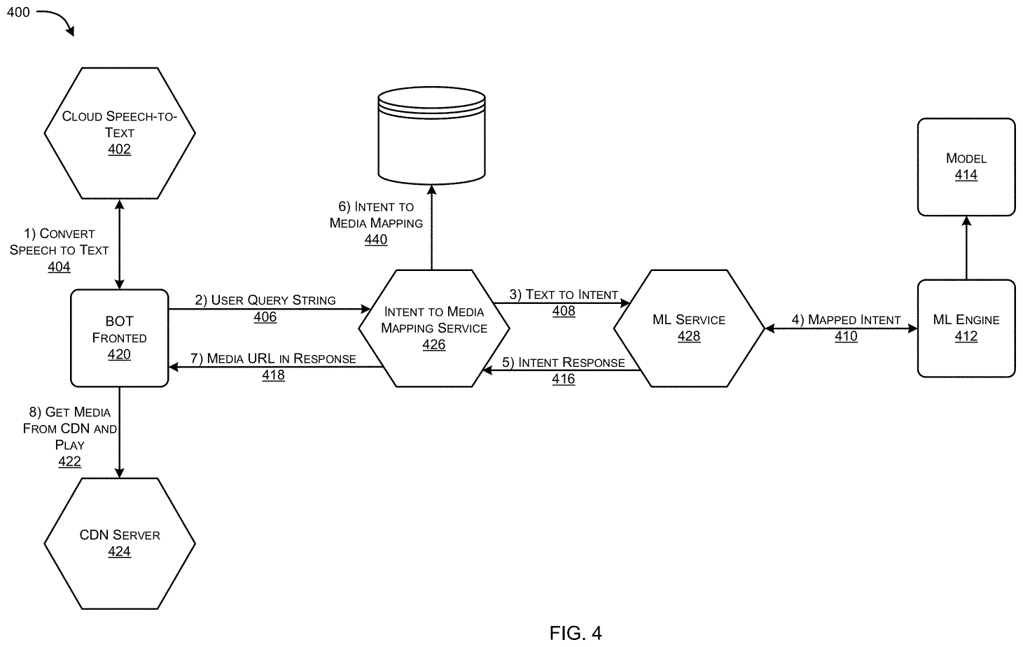

FIG. 4 illustrates an exemplary block flow diagram (400) depicting components of the system architecture involved in generation of an entity-specific multi-faceted bot, in accordance with an embodiment of the present disclosure. As illustrated, a user may start the Bot though OTT or IVR Channel (402). The user interaction may start and Bot frontend (420) may capture user query (406). The user query may be then sent to a backend service (426) which may query the Machine learning (ML) service (428). The ML service (428) may invoke the ML engine (412) which may map the correct model and find an appropriate model (414) for the bot. The Model (414) may return the appropriate intent for the query and the intent may be then returned to backend service (426). The Backend service (426) may return the appropriate media/text response to the frontend service (420) depending on the mode of interaction and language chosen by the user. The Bot frontend (420) may get the media files from the CDN server (424) and may deliver to the user. The process then may continue for other user queries.

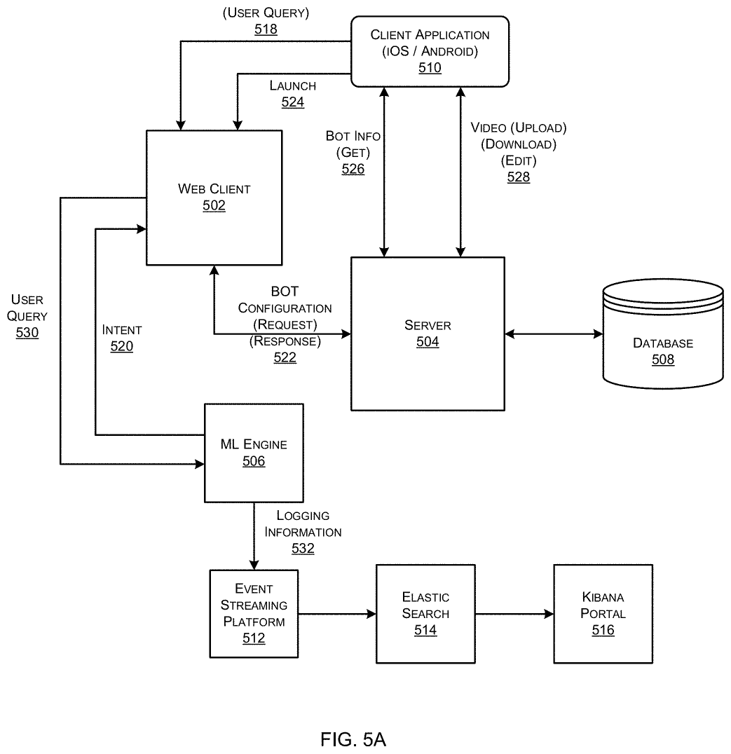

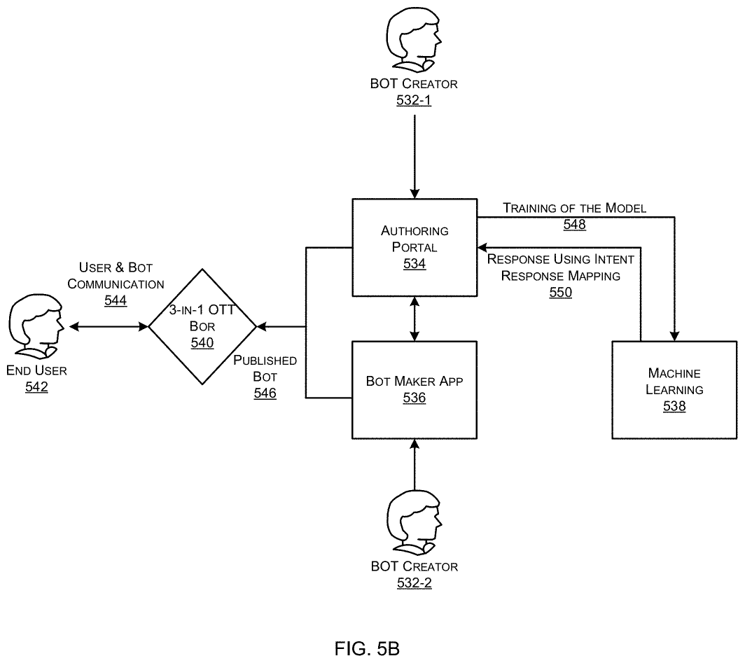

FIG. 5A-5B illustrate representations (500) for exemplary overviews of the system architecture and its implementation, in accordance with an embodiment of the present disclosure. As shown in FIG. 5A, the system architecture may include a bot maker engine architecture, while FIG. 5B illustrates the system architecture. As illustrated, the multifaceted bot may include a Bot-Maker App (536), an Authoring Portal (534), and a Machine Learning (ML) Engine (538) but not limited to the like. The Bot Maker App (536) may be used for publishing a Bot (546), democratizing access to state-of-the-art user (542) and the bot communication (544) that may enable an entity. The Bot maker app is with the end user (542) and may include a client application (IOS, Android and the like) (510). The Client Application (510) may correspond to a platform that may contain an Android and iOS client but not limited to the like that perform a server call to fetch the list of questions relevant to a particular Bot, for a user. The user can record videos for a particular question and save it. The client application (510) may allow the end user (542) to: Login by interacting with the backend server to login the user; select the bot by interacting with a server (504) to get bot information (526) such as list of bots, bot queries needed to be trained and the like; upload, review, delete and edit response (528); interact with the bots by launching (524) the web client and let user view and interact with the bot she/he trained.

In an exemplary embodiment, the server (504) may correspond to a platform that may send a list of questions relevant to a particular bot, for a user, to the client application (510). The videos recorded by the client application may be saved on the server (504) and the information may be maintained for the corresponding bot and user in the database (508). The server (504) may provide user registration and authentication, have a database (508) of user and bots, store a collection of response in video, audio and text format, provide interface to the bot maker app (536) to delete, edit the users video, audio or text, provide interface to the bot maker app (536) to get relevant list of bots and bot related information, provide Bot configuration (522) to a web client (502). The server (504) may also generate an intent file, video collection file, and trending questions file, which contain the mapping of the intent with the respective video. These files are sent to a web client (502).

In an exemplary embodiment, the web client (502) may act as a user interface of Bots, get the bot configuration (522) from the server (504), open a handle to Microphone and Camera of the client application (iOS or Android) (510), convert the user query (518) to text, using a speech to text engine but not limited to it, and interact with a Machine Learning (ML) Engine (506) to fetch intent and render the video, audio or text based on the user query (518). The web client (502) may further call the server (504) to obtain the relevant information to initialize a bot. The information may include the intent file, video collection file, and trending questions file, but not limited to the like.

The ML Engine (506) may include machine learning techniques (538) such as contextual analysis of the queries, identification of the intent on of the question being asked by the user, providing an appropriate response once the context is identified but not limited to the like. The ML engine may further identify the intent for the provided expression. Each expression may be passed through the ML engine and a probability is calculated for that intent, across the entire class of intents. The highest probability calculated for an intent, for any provided expression, may be considered as the primary contextual intent for that expression. The Database (508) may store the users, bots, questions, videos, and topics with a time stamp.

In an embodiment, an event streaming platform such as but not limited to Kafka (512) may correspond to a streaming platform that may maintain a queue of expressions, which contain information about the predictions performed by the ML engine (506) and an Elastic Search (514) may be used for monitoring and Dashboarding purposes through a monitoring interface such as but not limited to a Kibana portal (516) but not limited to it.

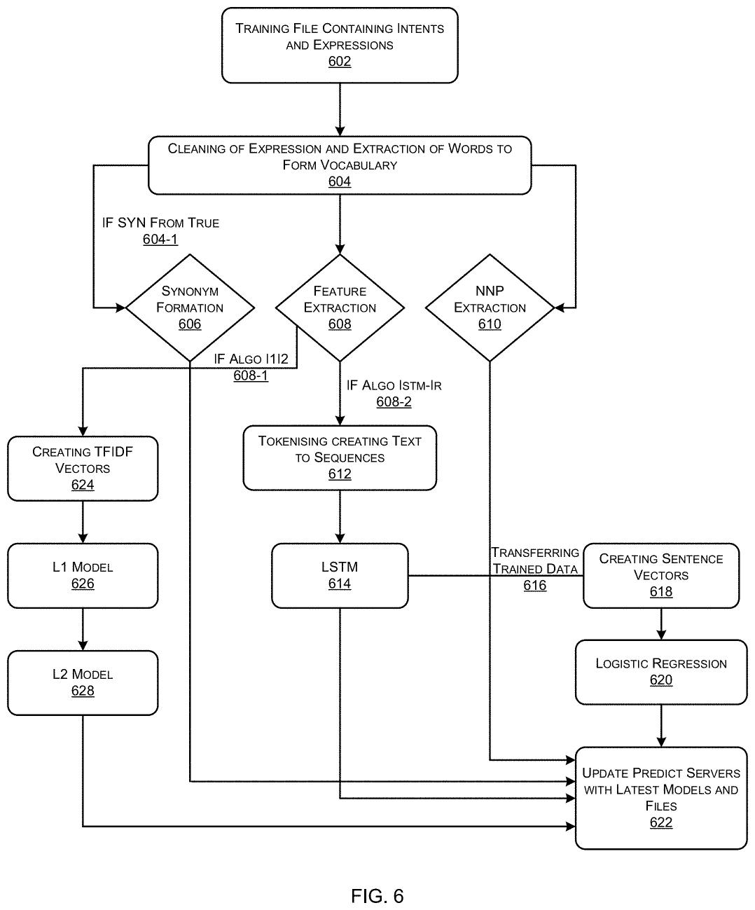

FIG. 6. Illustrates an exemplary flow diagram representation (600) of a method for generating the multi-faceted bot, in accordance with an embodiment of the present disclosure.

As illustrated, at block 602, a training file may contain intents and expressions. In an embodiment, each solution for a use case first may begin with a creation of a knowledge base which may solve an entity requirement. The dataset may contain expressions and the relevant categories or classes called Intents.

In an embodiment, based on such a dataset created for the knowledge base, a machine learning technique may be selected and the Knowledge base dataset may be trained using the Train Service. This Creates a Model which may be used for Prediction (intent classification) using the Predict Service. Based on the intent returned by the predict Service for a new expression, the backend selects a response mapped to it and returns it to the user. Before the model is trained, there are several Data cleaning and feature extraction processes that are carried out at block 604. These could be ancillary processes such as Synonym formation at block 606, Proper Noun (NNP) Extraction at block 610, feature extraction at block 608 such as white space removal, stemming of words, punctuation removal, special character removal and the like which can enable the training and predictions to be more accurate. Once the model is trained, all the files created during Training are pushed to the predict servers at block 622.

In an embodiment, the machine learning technique for video Bots (chat bots which output response as pre-recorded videos) may be LSTM-LR at block 614 but not limited to it. The LSTM-LR may be a culmination of at least two popular techniques such as Logistic Regression (LR) and the other a Neural Network based on Bi-Directional LSTM cells but not limited to the like. The Knowledge Base may be first used to train the LSTM neural net using categorical cross entropy as a loss function and Adam optimizer taken from feature extraction at block 608 through tokenizing creating text to sequences at block 612 that may be supervised learning task (both the input and the output are shown to the model while training). Each layer of the neural net may extract some information during training to minimize the loss function and retrain the weights of the layer in this process) may be passed to Logistic Regression (LR) at block 620 which may create sentence vectors from the expressions at block 618. The sentence vectors at block 618 act as input for LR at block 620 which uses a sigmoid function but not limited to it to calculate the probabilities for each class and returns the class which has the highest probability.

In another embodiment, an L1L2 technique at blocks 626 and 628 may be provisioned primarily for voice-based bots. Along with training models, as mentioned earlier several other Knowledge base specific files may be created synonyms corresponding to variations of a word in the training set to increase the vocabulary of the train set and NNPs corresponding to proper nouns in the training set for enhancing the results of the predictions related to the Knowledge base may be integral part of the predict service at block 622.

In an embodiment, intent classification may be as a process where a user query may be fed as an input to a machine learning model and may return an Intent which helps in understanding and contextualizing the user query and perform suitable actions on the user query.

In an embodiment, the predict Service at block 622 may be used for making inferences from the trained model. The backend may take the user query in the form of a string and call the Predict Service. The query may be first cleaned of any special characters. To reduce the response complexity several rule-based checks may be placed before the model prediction. Each check may serve as a separate purpose such as Hotfix for quick fixes to user query and good additional data for training but not limited to the like.

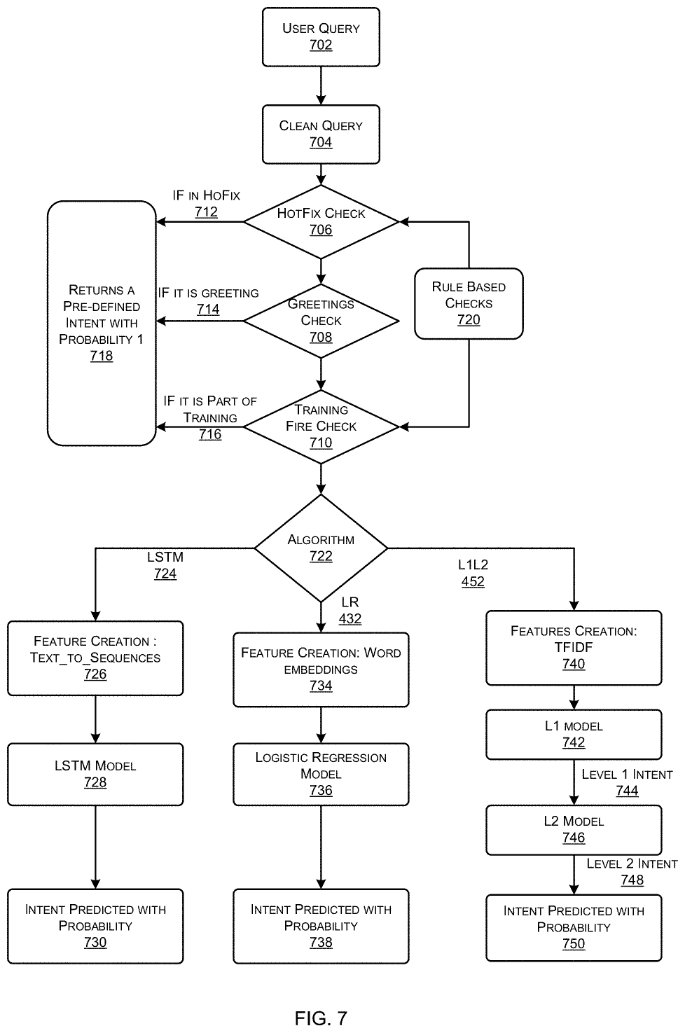

FIG. 7 illustrates an exemplary flow diagram depicting bot-as-a-service platform in accordance with an embodiment of the present disclosure.

As illustrated, greetings check at block 708 for common everyday greetings and Training File Check at block 710 may be performed after a user query is obtained at block 702, cleaned at block 704 and Hotfix checked at block 706. In an embodiment, if the response for a query is not found in any of these checks, the query may be converted to features at blocks 728, 736 and 744 that may correspond to mathematical representation of expressions which may be fed to the models such as LSTM model at block 730, LR model at block 738 and L1L2 model at block 746, for training using the pre-defined feature extraction technique or algorithm such as LSTM-LR and L1L2 at blocks 724, 726 and 740 while training. The Trained models at blocks 730, 738 and 746 may return the intent class as output for the predict service at blocks 732, 740 and 748 which may be then used by the backend for further processing. The classification process for newer expressions may be a predictive process using the mathematical model built. It may return an intent or class that the new expression could possibly belong to and may help in understanding and contextualizing the user query and perform suitable actions on them. The major use case may lie in creation of a virtual assistant applications.

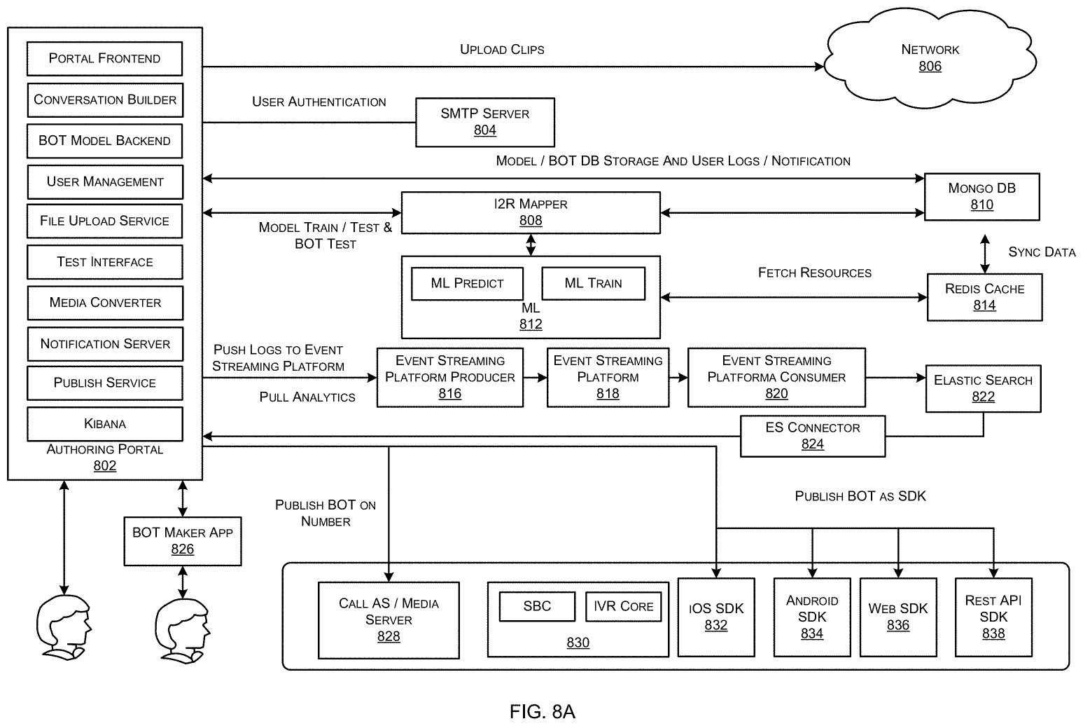

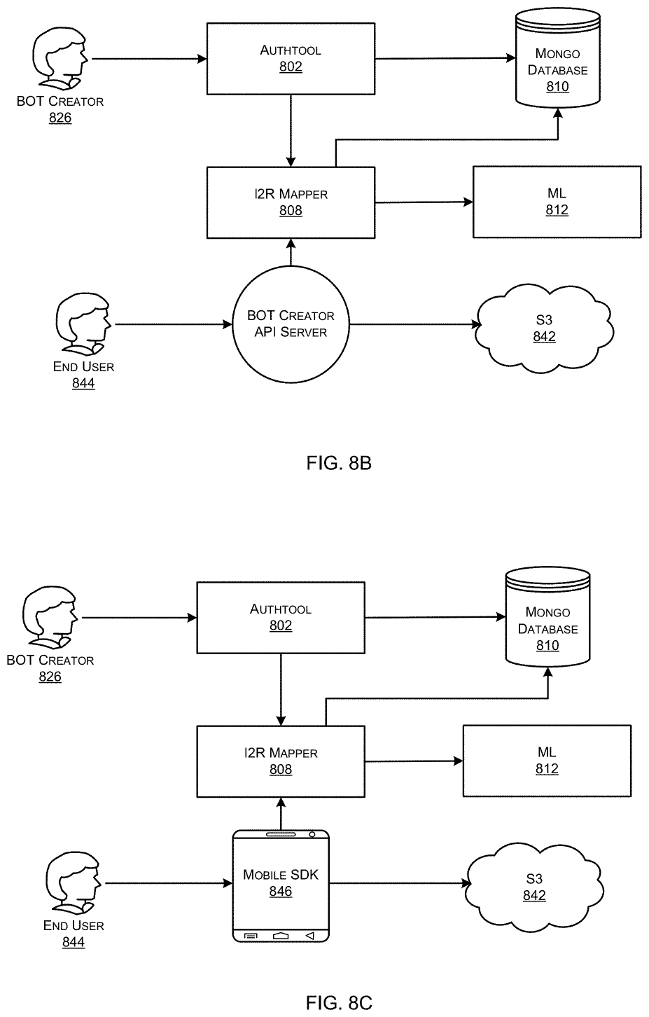

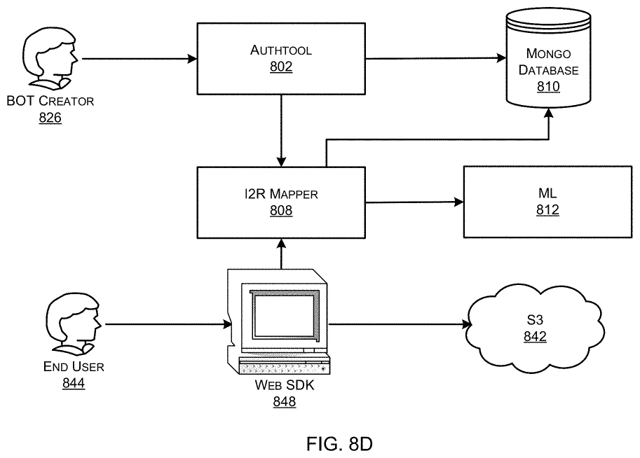

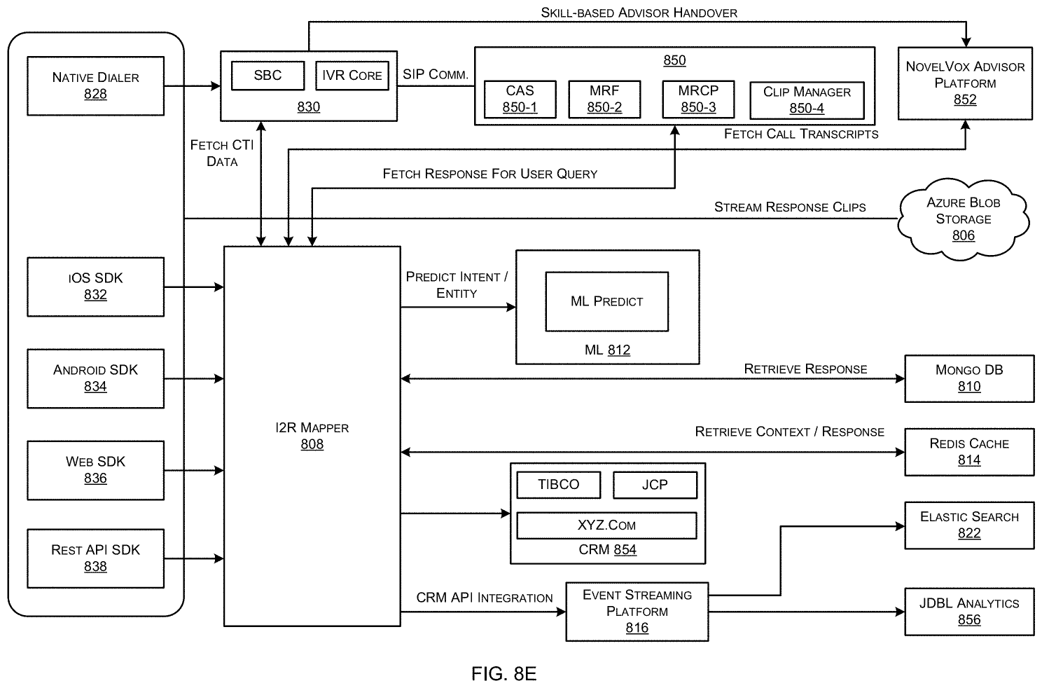

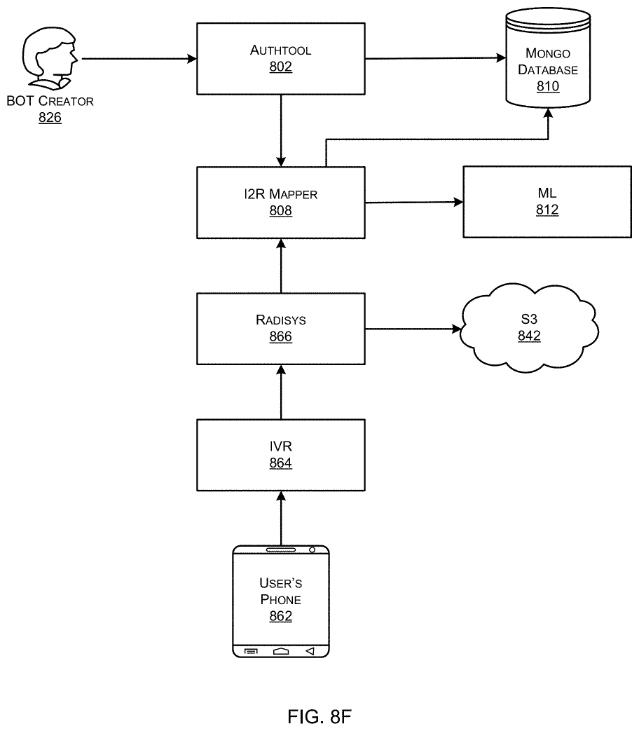

FIGS. 8A-8F illustrate exemplary representations of architecture of training using authoring Portal and bot-Maker module, in accordance with an embodiment of the present disclosure.

As illustrated in FIG. 8A, in an aspect, an Authoring Portal (802) may correspond to an integrated portal for quick creation and publishing of Bot on channel of choice such as Native Dialer, IVR, VOIP, Mobile App, Portal, Social Media (828 and 830) that may enable consistent quality of Customer Care. The authoring portal (802) may provide any or a combination of managing user profile and password, viewing existing chatbot models, managing the life cycle of a model such as creating a model, adding expressions and intents to a model, training a model, testing a model, publishing a model, sorting and searching models, managing the life cycle of a chatbot that may include creating a chatbot, adding text, audio, and video responses to a chatbot, testing a chatbot, publishing a chatbot, generating SDK or REST API to invoke a chatbot (832-838) but not limited to the like. As per client requirement the Video for the Bot could be produced in Studios or through Bot maker Application. HD videos may be encoded and segmented to make them for adaptive delivery. The media may be DRM protected through an SMT Server (804) to prevent unauthorized access. The media may be hosted on cloud CDN (806) to provide high availability and reduce latency with Adaptive media delivery capability. Queries and intent mapping may be created using the Authoring Portal. The Authoring portal may have capability of creating bots in an intuitive wizard flow and also the have capability to test the bot before publishing through an I2R Mapper (808). All the Bots and relevant models would be persisted in database such as a MongoDB (810) but not limited to it. The MongoDB (810) may be coupled to a Redis Cache (814) but not limited to it. A classification process for newer expressions fetched from the Redid cache (814) may be a predictive process using the mathematical model built at ML engine (812) that may return an intent or class that the new expression could possibly belong to and may help in understanding and contextualizing the user query and perform suitable actions on the user queries. Microservices may be logged into the Kafka (816, 818, 820) that may be exposed as published services to the authorized user through an elastic search (822) and ES connector (824).

As illustrated in FIG. 8B, in an aspect, an API design architecture may include a Bot Creator (826) that may be configured to create a model, add expressions to the model, m train and publish the model. Once the data is published, the bot may be created using the published model and responses may be added to it. Post adding the responses, the bot may be then published so that end users (844) can use the model. An Authtool (802) may be a portal given to the bot creator to create models and bots. There may be a capability for the bot creator to collaborate with other bot creators from an entity and work on creating a model or a bot. The architecture may further include an I2R Mapper (808) that may be configured to play a role of the collecting the data from the database and organizing the data in a proper format, writing the data into a file and finally sending the data to an ML engine (812) for training of the data. Along with the training, the bot creator may also provide an interface to the outside world by the means of an API which can be used to predict the result of a query provided by the user. The bot creator (826) may include at least two APIs, a first API for creating the user session and a second API for prediction of an intent. The ML Engine (812) may be the most crucial component of the entire solution. The ML Engine (812) may get the data in file from the I2R Mapper and create and train a model inside the ML Engine (812). Post training the ML Engine (812) may be capable to predict intent based on the user queries. The required parameters for the ML Engine (812) to predict an intent may be the model name and the user's query.

In an embodiment, an S3 (842) may be a cloud storage provided by AWS but not limited to the like. The responses uploaded by the user, which may be in audio or video format may be stored in the S3. The data in the S3 (842) can be uploaded only through the Authtool portal (802) and the data present on the S3 (842) may be available publicly. A Bot Creator's API Server (845) may correspond to a server hosted at the bot creator's end. The bot creator (826) may have an interface for an end user (844) who may correspond to one who may ask for the queries and gets the response. Here the Bot Creator's API Server (845) may consume the API as a service from the I2R Mapper (808) and may sends the response as per the requirement.

As illustrated in FIG. 8C, in an aspect, a mobile SDK architecture may include a Bot Creator (826) that may be configured to create a model, add expressions to the model, m train and publish the model. Once the data is published, the bot may be created using the published model and responses may be added to it. Post adding the responses, the bot may be then published so that end users (844) can use the model. An Authtool (802) may be a portal given to the bot creator to create models and bots. There may be a capability for the bot creator to collaborate with other bot creators from an entity and work on creating a model or a bot. The architecture may further include an I2R Mapper (808) that may be configured to play a role of the collecting the data from the database and organizing the data in a proper format, writing the data into a file and finally sending the data to an ML engine (812) for training of the data. Along with the training, the bot creator may also provide an interface to the outside world by the means of an API which can be used to predict the result of a query provided by the user. The bot creator (826) may include at least 2 APIs, a first API for creating the user session and a second API for prediction of an intent. The ML Engine (812) may be the most crucial component of the entire solution. The ML Engine (812) may get the data in file from the I2R Mapper, and create and train a model inside the ML Engine (812). Post training the ML Engine (812) may be capable to predict intent based on the user queries. The required parameters for the ML Engine (812) to predict an intent may be the model name and the user's query.

In an embodiment, an S3 (842) may be a cloud storage provided by AWS but not limited to the like. The responses uploaded by the user, which may be in audio or video format may be stored in the S3. The data in the S3 (842) can be uploaded only through the Authtool portal (802) and the data present on the S3 (842) may be available publicly. A mobile SDK (846) may be created and provided to the bot creator wherein the mobile SDK (846) can be used while creating the mobile application for Android as well as IOS devices but not limited to it. The mobile SDK (846) can be integrated into the existing mobile application by importing a package and passing minimal information required to instantiate and connect to the server. No extra efforts may be needed on the mobile application development side. Everything may be handled by the SDK, which may open the entire interface for chat in text, audio and video mode just on a click of a button.

As illustrated in FIG. 8D, in an aspect, a Web SDK architecture may include a Bot Creator (826) that may be configured to create a model, add expressions to the model, m train and publish the model. Once the data is published, the bot may be created using the published model and responses may be added to it. Post adding the responses, the bot may be then published so that end users (844) can use the model. An Authtool (802) may be a portal given to the bot creator to create models and bots. There may be a capability for the bot creator to collaborate with other bot creators from an entity and work on creating a model or a bot. The architecture may further include an I2R Mapper (808) that may be configured to play a role of the collecting the data from the database and organizing the data in a proper format, writing the data into a file and finally sending the data to an ML engine (812) for training of the data. Along with the training, the bot creator may also provide an interface to the outside world by the means of an API which can be used to predict the result of a query provided by the user. The bot creator (826) may include at least 2 APIs, a first API for creating the user session and a second API for prediction of an intent. The ML Engine (812) may be the most crucial component of the entire solution. The ML Engine (812) may get the data in file from the I2R Mapper and create and train a model inside the ML Engine (812). Post training the ML Engine (812) may be capable to predict intent based on the user queries. The required parameters for the ML Engine (812) to predict an intent may be the model name and the user's query.

In an embodiment, an S3 (842) may be a cloud storage provided by AWS but not limited to the like. The responses uploaded by the user, which may be in audio or video format may be stored in the S3. The data in the S3 (842) can be uploaded only through the Authtool portal (802) and the data present on the S3 (842) may be available publicly. A Web SDK (848) may be created and provided to the bot creator wherein the Web SDK (848) can be used as a web page. The Web SDK (848) may be provided in terms of an iFrame with steps to follow and integrate into the web page. The Web SDK (848) may be such that the Web SDK (848) may open up a chat popup and may show the interface for the end user (844) to ask questions and get response in text, audio and video format. The Web SDK (848) may also provide the necessary provision to get permission of the mic and camera as per the requirement.

As illustrated in FIG. 8E, in an aspect, an architecture for prediction using the ML engine (812) and the I2R mapper (808) for the bot created using Authoring Portal (802) and Bot maker module (826). The architecture for prediction may incorporate the integration of third-party CRM APIs (854) but not limited to it.

As illustrated in FIG. 8F, in a way of example and not as a limitation, a set of queries can be generated at a user phone (862) which is then sent to the IVR (860) which is then accessed by Radysis (866). The MongoDB (810) may be coupled to the Redisys. A classification process for newer expressions fetched from the Redid cache (814) may be a predictive process using the mathematical model built at the ML engine (812) that may return an intent or class that the new expression could possibly belong to. The responses uploaded by the user, which may be in audio or video format may be stored in the S3. The data in the S3 (842) can be uploaded only through the Authtool portal (802) and the data present on the S3 (842) may be available publicly. The Authoring portal (802) may create bots test the bot before publishing through the I2R Mapper (808). All the Bots and relevant models may persist in the MongoDB (810) but not limited to it.

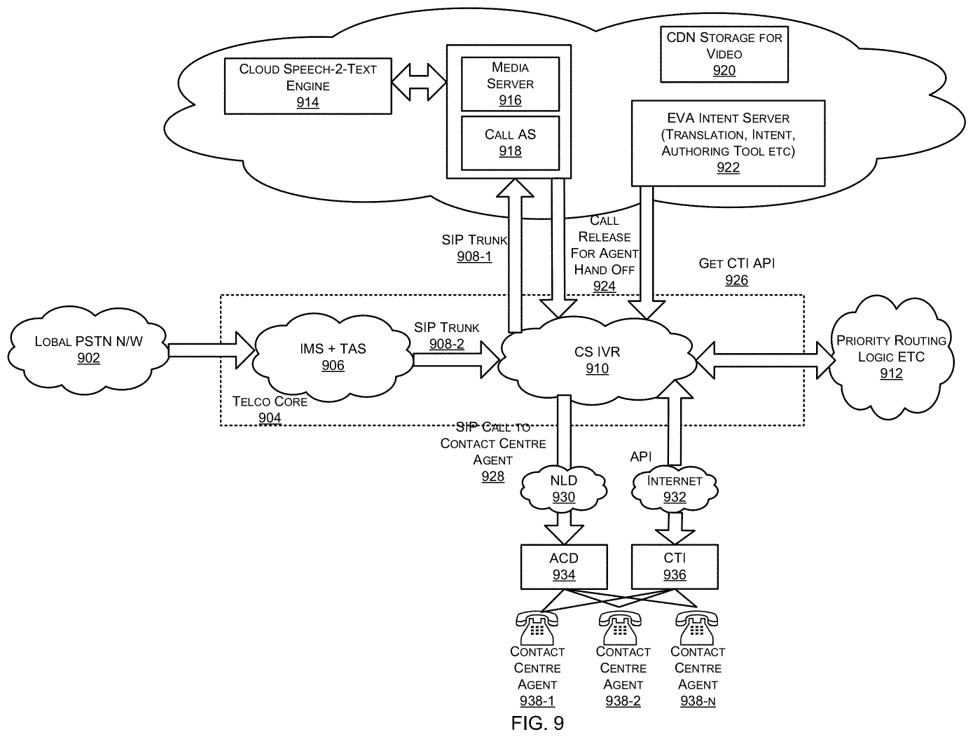

FIG. 9 illustrates an exemplary representation of an architecture of the Native Dialer flow (900), in accordance with embodiments of the present disclosure.

As illustrated, in an aspect a call may be placed via native dialler. An existing IVR (910) may terminates the call on intent service to handle automated conversation. An Intent Server (922) may hold conversation and answer user queries. If the user requires additional assistance, the call may be routed via CTI link (936) to agents (938) in queue, based on skills and availability.

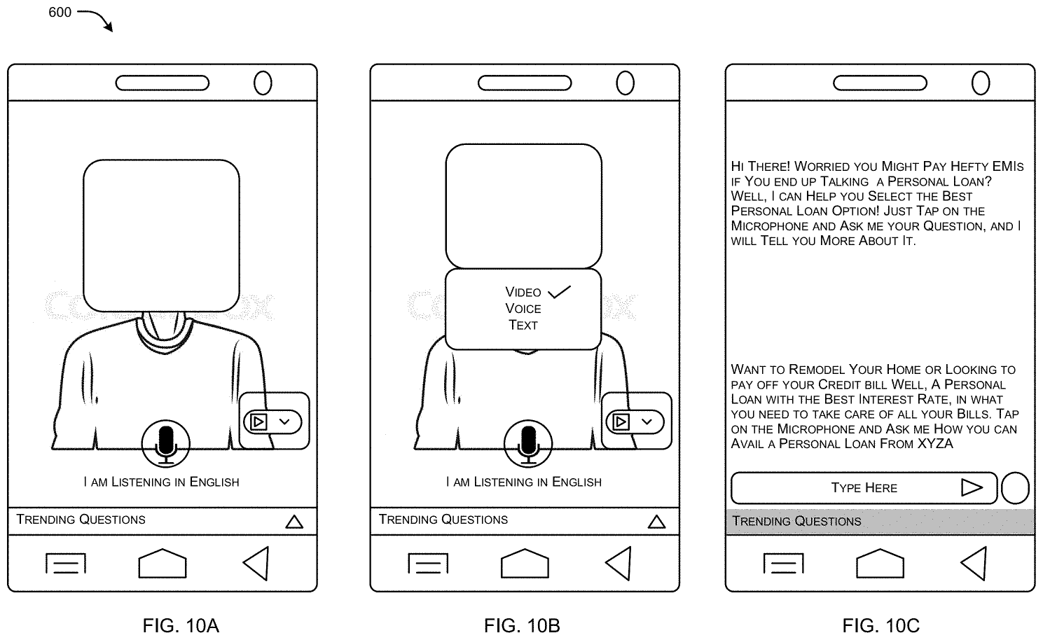

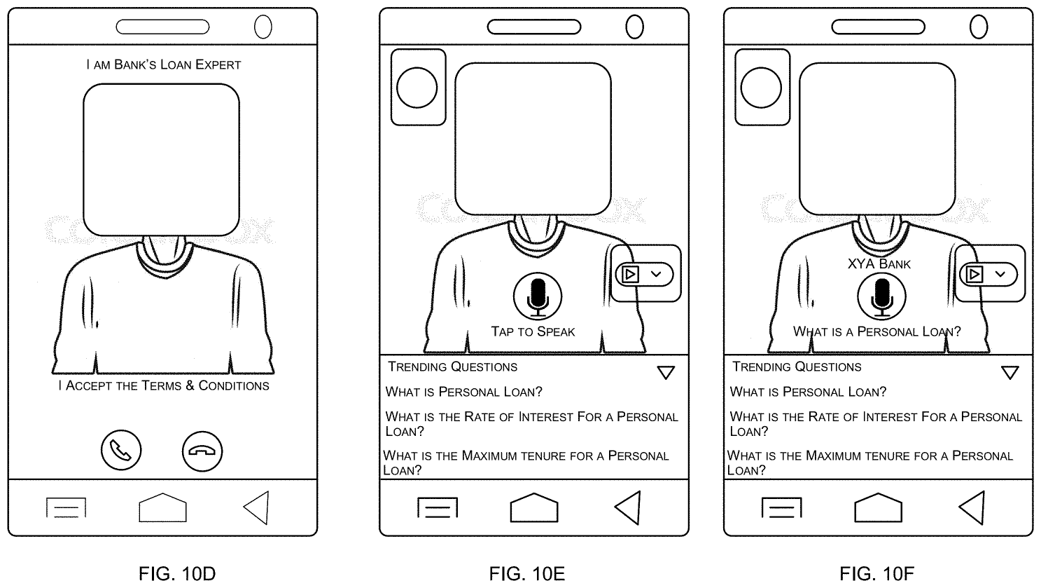

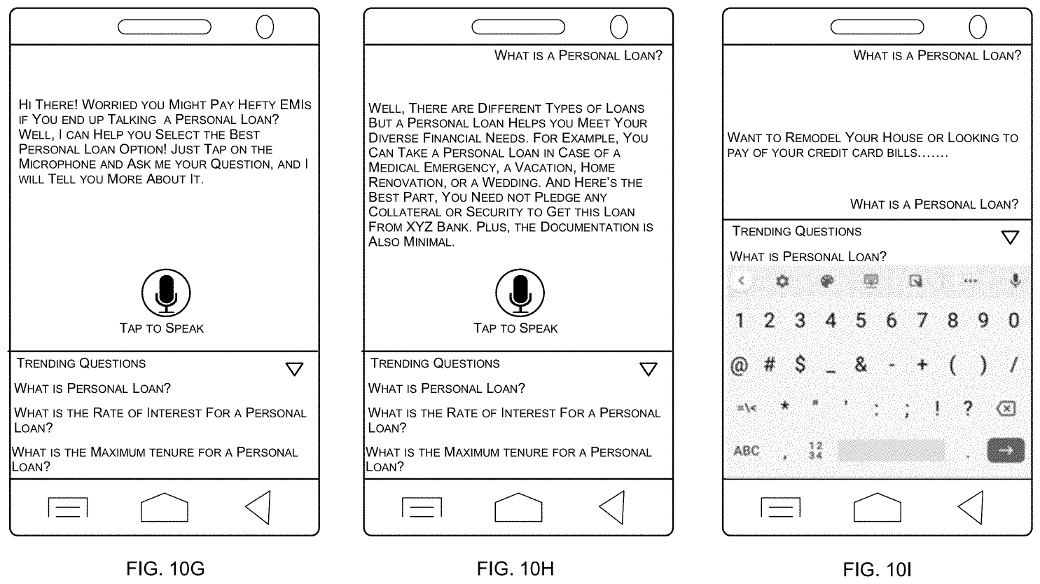

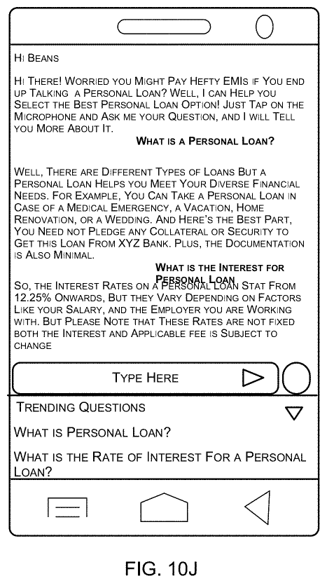

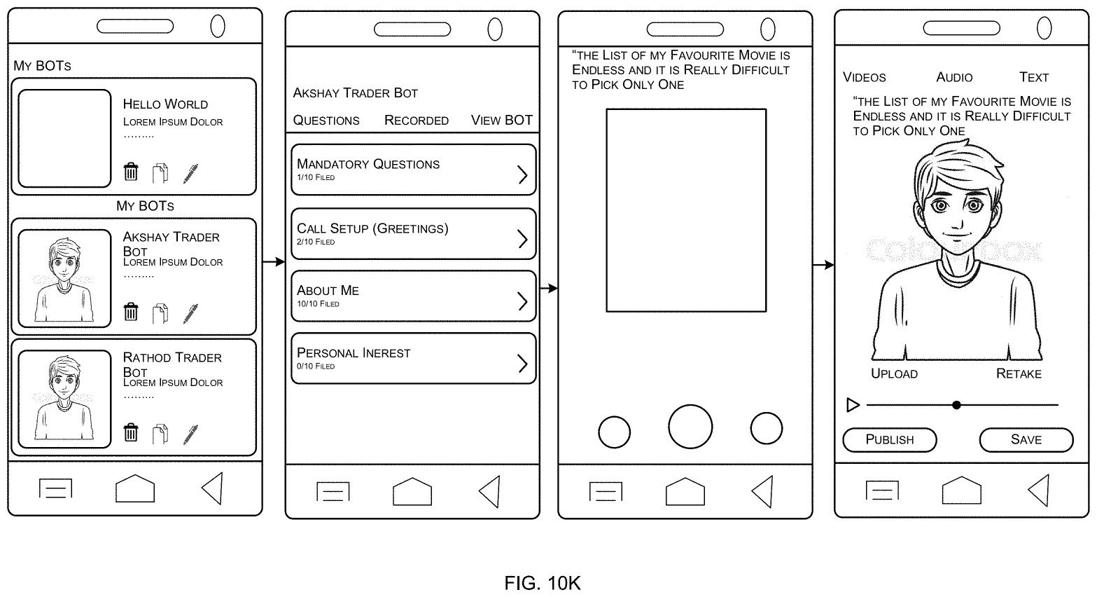

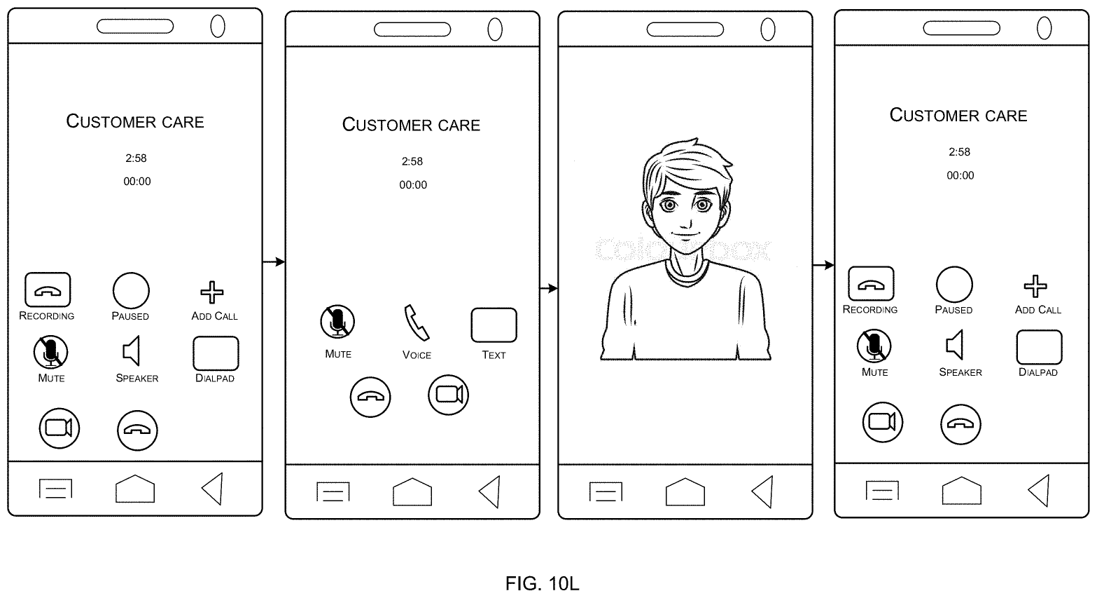

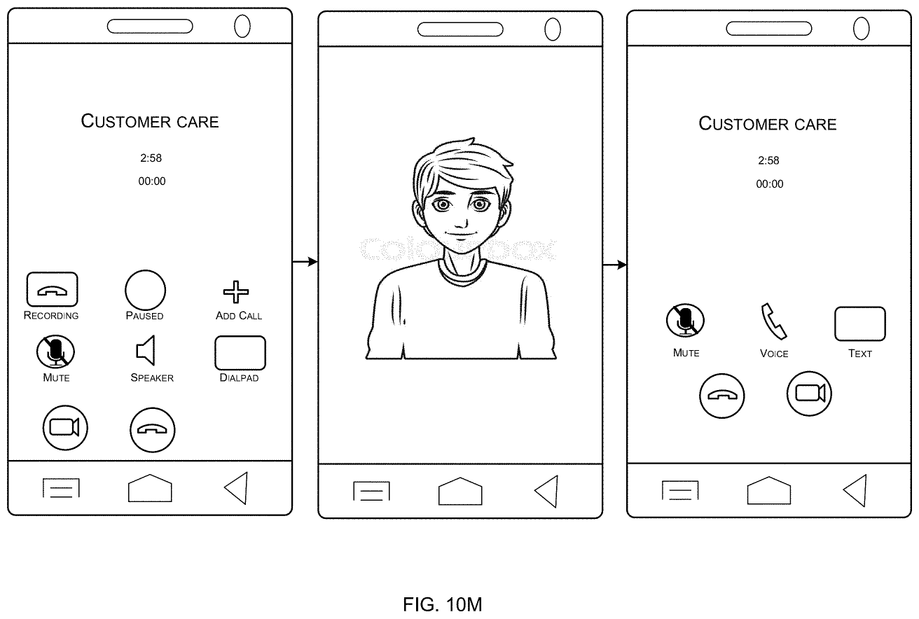

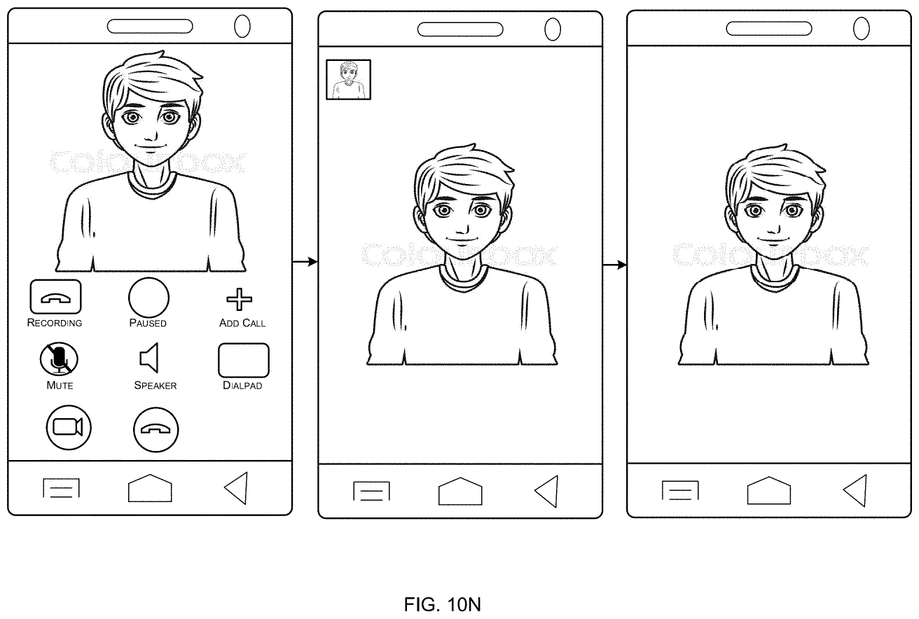

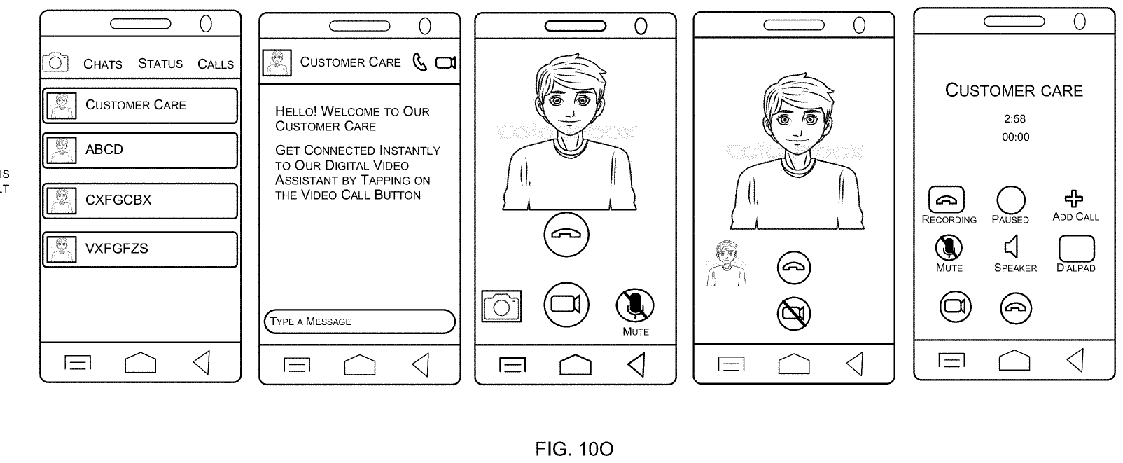

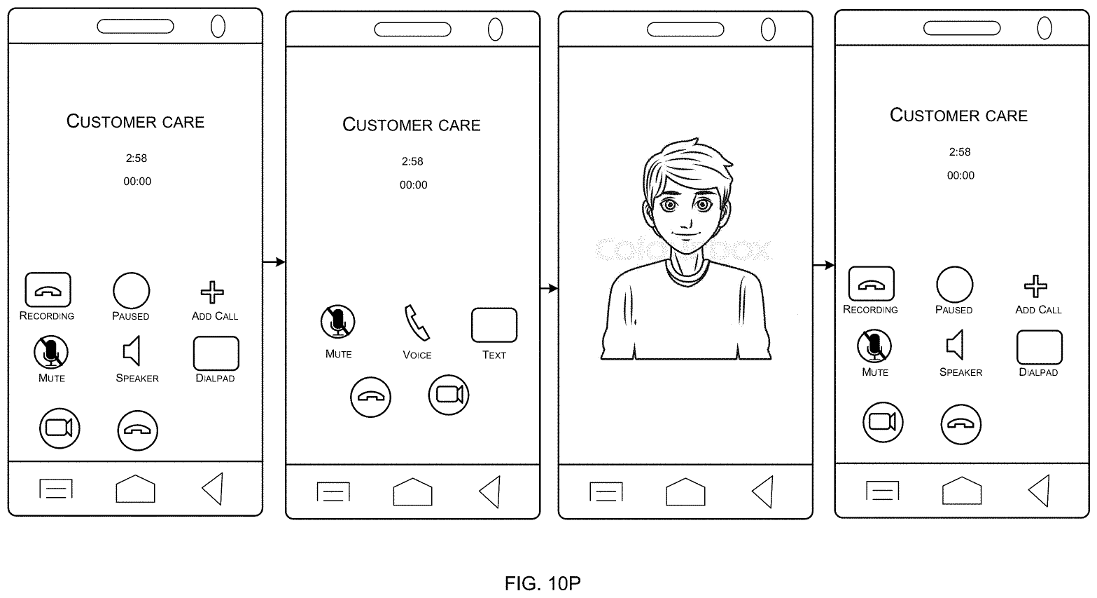

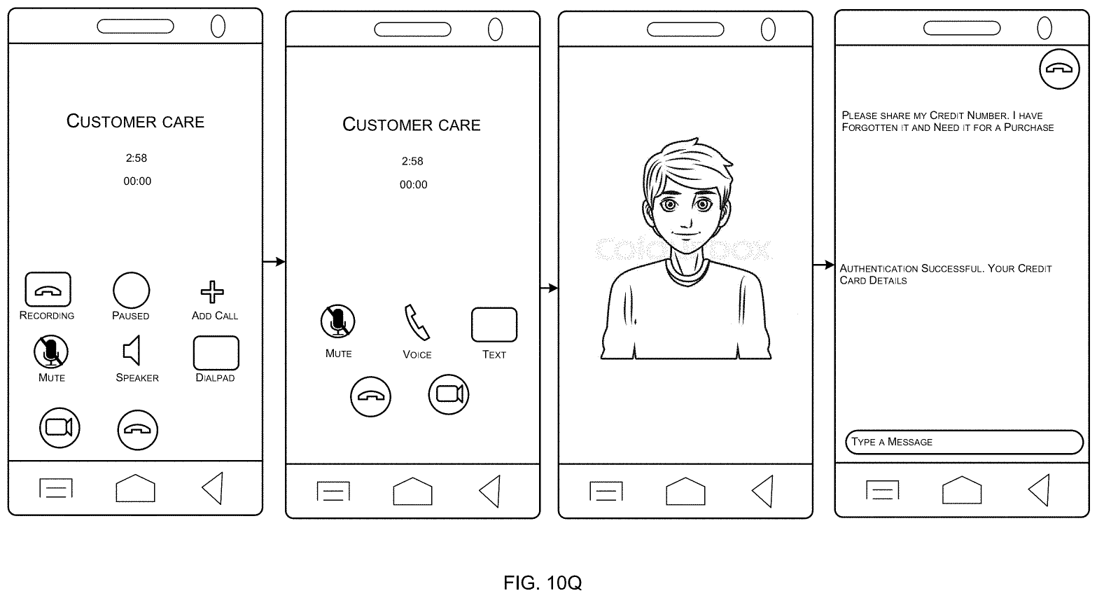

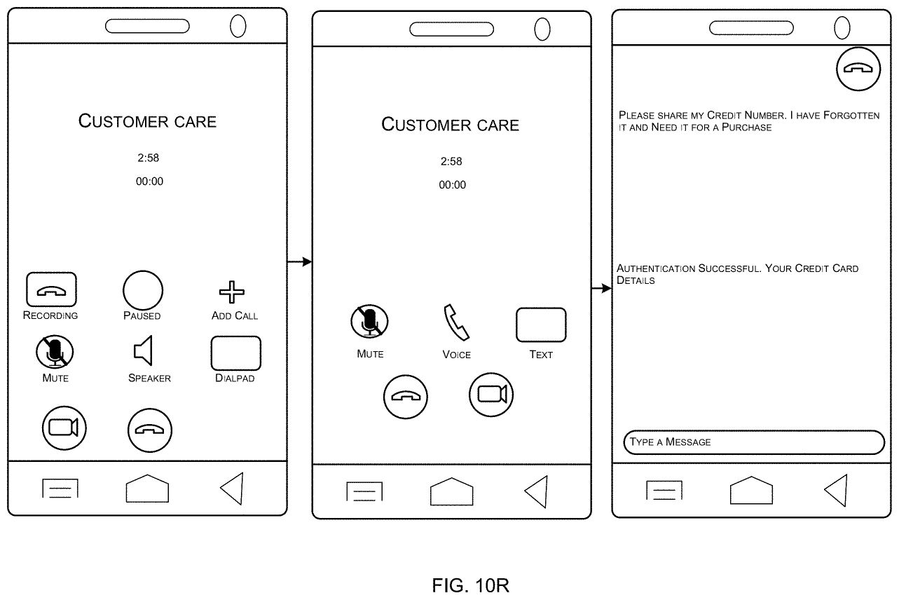

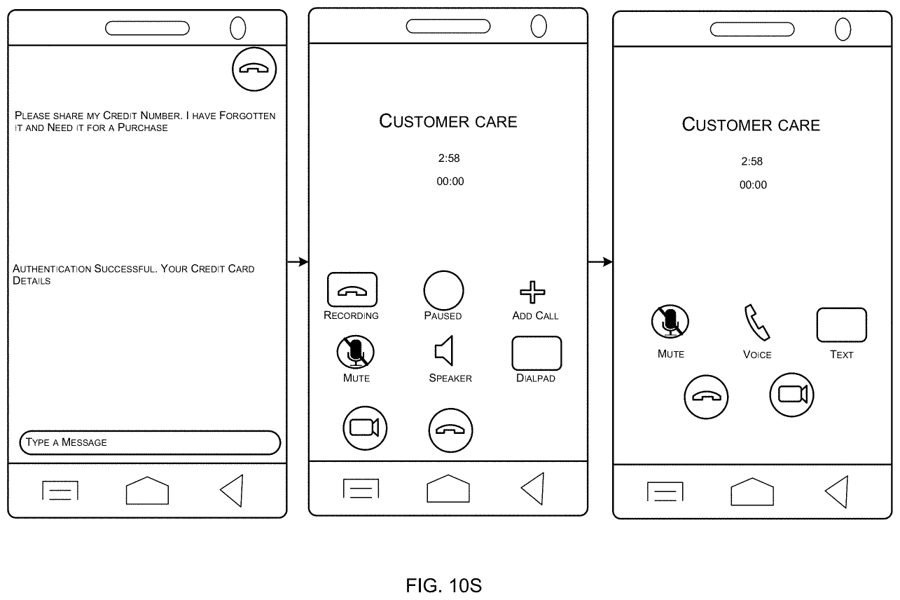

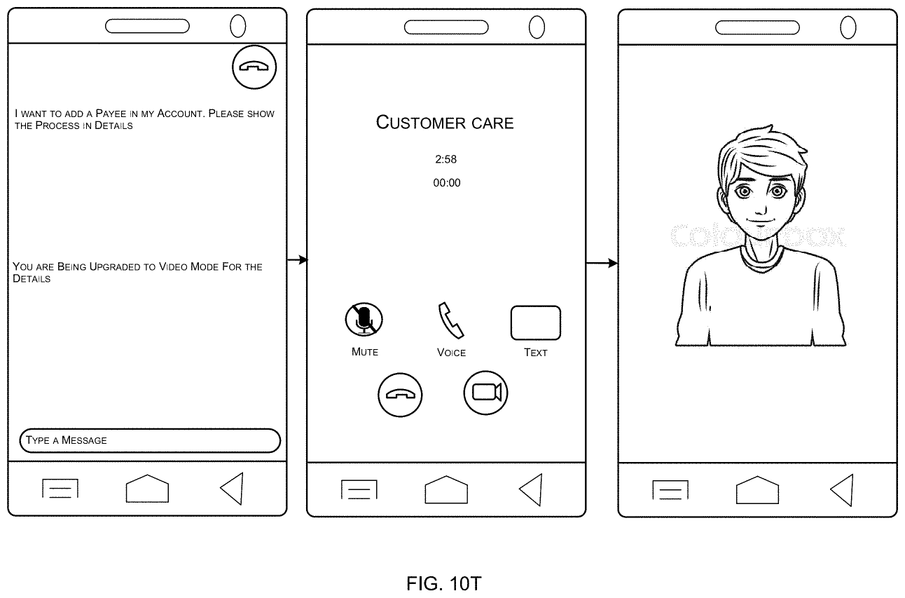

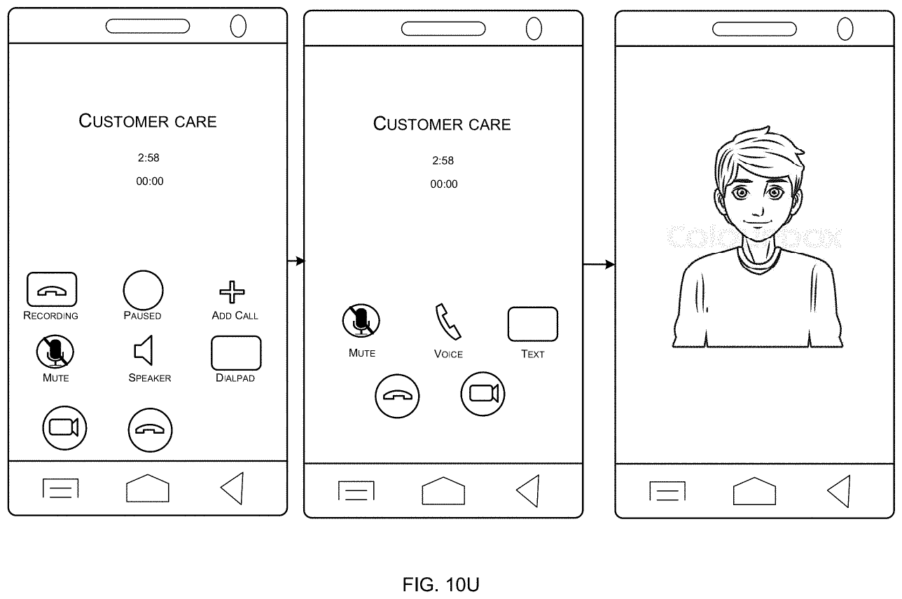

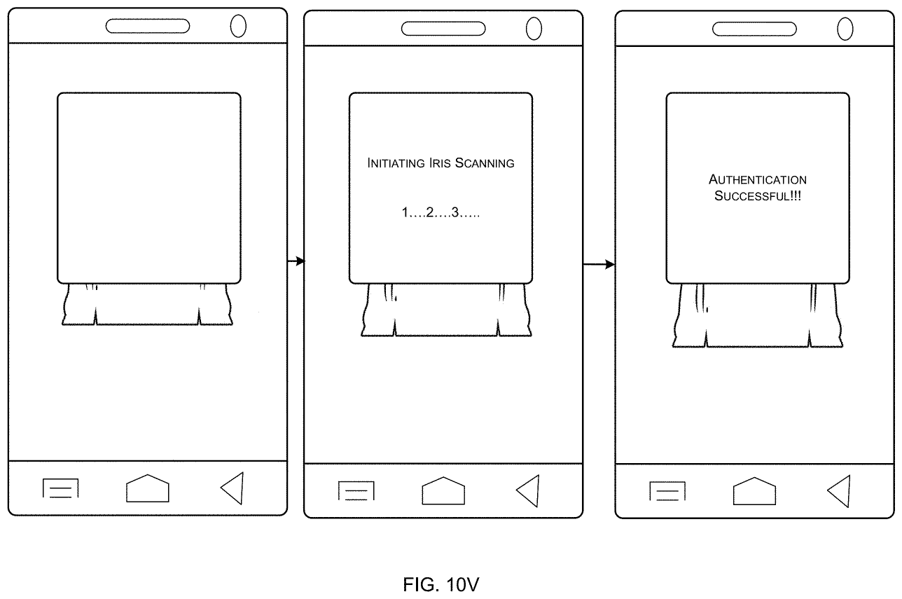

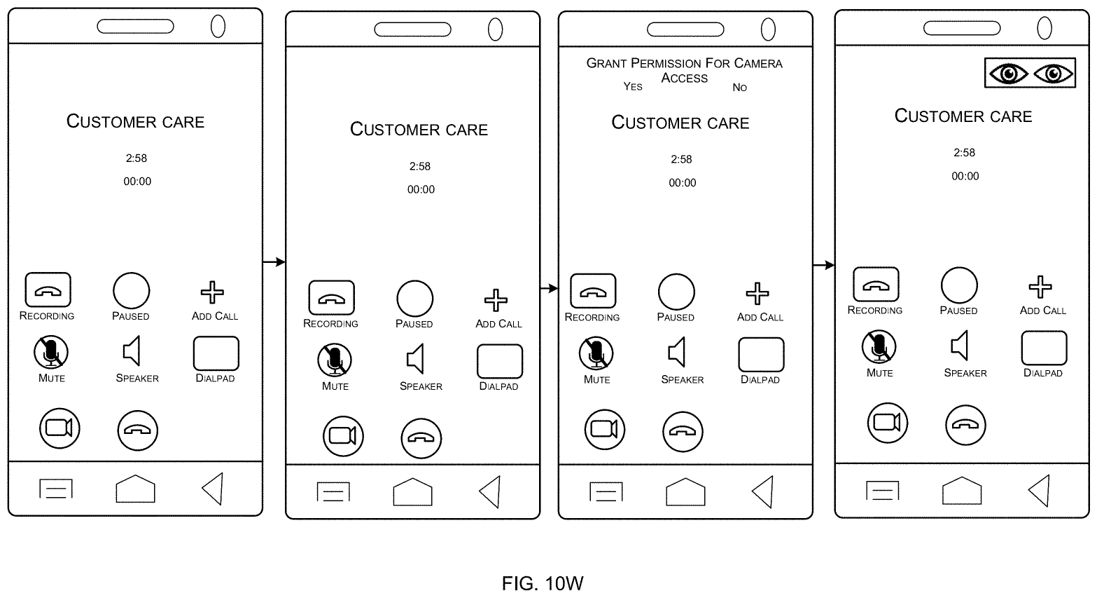

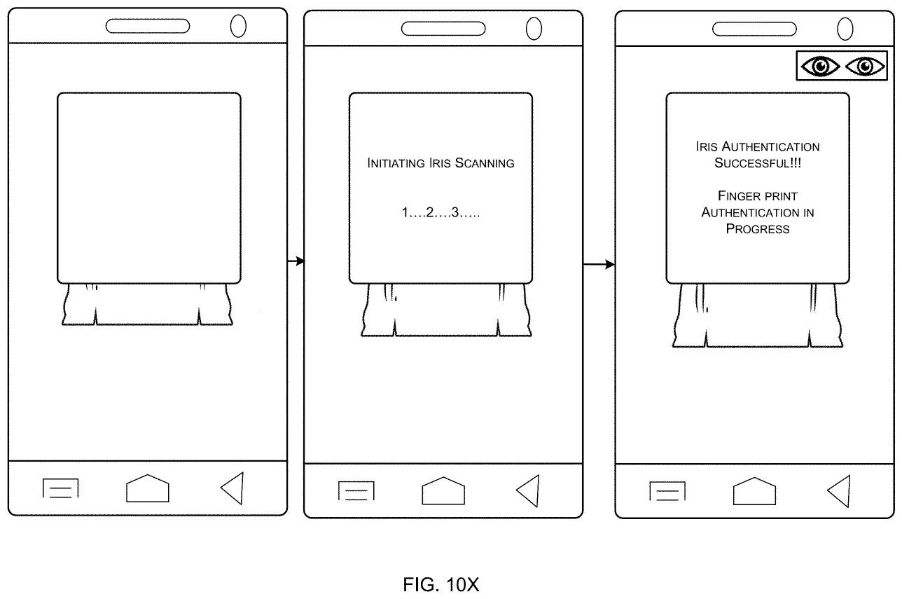

FIGS. 10A-10X illustrate representations of the exemplary working of the system (110) and method (300), in accordance with embodiments of the present disclosure. As illustrated by way of examples and not as limitations, the FIGS. 10A-10X illustrate the numerous ways in which the customer will be able to interact within the environment. The figures illustrate exemplary scenarios and call flows for interaction possibility between a Customer, a BOT and an Agent. FIG. 10A-10C depict exemplary implementations how a bot can be toggled between chat, audio and video services. FIG. 10 D depicts a bot launch display. A user can view the Terms and Conditions by clicking on a Terms and Condition (T&C) link and by pressing the green button the user may accept the T&C and may start the bot. FIG. 10E-10F depict video mode inducers where videos may be displayed played in the beginning to give the user general instructions. The may User need to press a microphone button but not limited to it to ask a question or choose from trending questions. A video clip may be played in response to the user query.

FIG. 10 G-10H depict audio mode inducers where audios may be played in the beginning to give the user general instructions but not limited to it. The user may need to press the microphone button to ask a question or choose from trending questions. An audio clip may be played in response to the user query.

FIG. 10 I-10J depict text mode inducers where text messages may be shown in the beginning to give the user general instructions but not limited to it. The user may need to type a question or choose from trending questions. A text transcript may be displayed in response to the user query.

FIG. 10K illustrates a user Interface of the BOT-Maker Application by way of an example and not as a limitation. FIG. 10L illustrates an exemplary representation of an inbound Voice IVR Call—Voice to Video BOT to Agent Handoff. FIG. 10 M illustrates an exemplary representation of an Outbound Voice or Video Call with Agent Handoff. FIG. 10 N illustrates an exemplary representation of an Inbound Video Call to Bot with Agent Handoff while FIG. 100 FIG. 10 M illustrates an exemplary representation of a VOIP Integration. FIG. 10P-10R illustrate exemplary representations of Auto Downgrade features from Video to Audio, Video to Text and Audio to Text respectively while FIG. 10S-10U illustrate exemplary representations of Auto upgrade features from Text to Audio, Text to Video, and Audio to Video respectively. FIG. 10V-10W illustrate exemplary representations of Iris Scanning for Biometric Authentication for video and audio respectively while FIG. 10X illustrates a dual level authentication for video that may be applicable for audio as well.

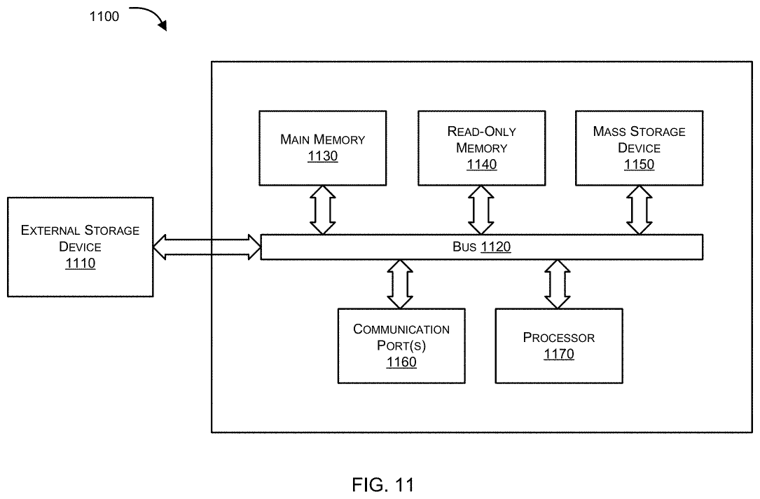

FIG. 11 illustrates an exemplary computer system in which or with which embodiments of the present invention can be utilized in accordance with embodiments of the present disclosure. As shown in FIG. 11, computer system 1100 can include an external storage device 1110, a bus 1120, a main memory 1130, a read only memory 1140, a mass storage device 1150, communication port 1160, and a processor 1170. A person skilled in the art will appreciate that the computer system may include more than one processor and communication ports. Examples of processor 1170 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 1170 may include various modules associated with embodiments of the present invention. Communication port 1160 can be any of an RS-232 port for use with a modem based dialup connection, a 10/100 Ethernet port, a Gigabit or 10 Gigabit port using copper or fiber, a serial port, a parallel port, or other existing or future ports. Communication port 1160 may be chosen depending on a network, such a Local Area Network (LAN), Wide Area Network (WAN), or any network to which computer system connects. Memory 1130 can be Random Access Memory (RAM), or any other dynamic storage device commonly known in the art. Read-only memory 1140 can be any static storage device(s) e.g., but not limited to, a Programmable Read Only Memory (PROM) chips for storing static information e.g., start-up or BIOS instructions for processor 1170. Mass storage 1150 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 1120 communicatively couples processor(s) 1170 with the other memory, storage and communication blocks. Bus 1120 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 1170 to software system.

Optionally, operator and administrative interfaces, e.g. a display, keyboard, and a cursor control device, may also be coupled to bus 1120 to support direct operator interaction with a computer system. Other operator and administrative interfaces can be provided through network connections connected through communication port 1160. The external storage device 1110 can be any kind of external hard-drives, floppy drives, IOMEGA® Zip Drives, Compact Disc—Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Thus, the present disclosure provides a unique and inventive solution for facilitating generation of one or more automated visual responses to a user query based on a machine learning based architecture, thus providing an automated and improved user experience solution. The solution offered by the present disclosure ensures that the response generation is accurate/precise due to the involvement of well-trained ML engine. Further, other benefits include quick go-to-market strategy for those entity/organizations that do not wish to expend excessive time in developing and managing the technology as the system of the present disclosure is a ready to implement solution with no special training in ML and without need for a professional expert/knowledge. The present disclosure can lead to huge cost savings by way of studio costs in recording queries and responses, otherwise required conventionally. Further, the recording of the videos can be done at leisure and using a background that is most appropriate for the promotion activity. It is important to realize that the system is easy to use, has ability to re-record videos should there be a change in the content requirement, ability to record with different models/speakers, ability to support multiple languages, is highly scalable, allowing the users to enhance the scope of coverage, if needed. The system further also benefits the user/customer by way of checking videos about operational service by the user before he/she takes a decision on the services being promoted and also allows the end user of the promotion to choose the questions he/she wants information on, rather than be given information which may not be of interest. The technical advantages of the present disclosure also includes an ability of the technology to cater to all languages, easy-to-use Interface, the system caters to both Android, Kai OS and IOS and the like, scalability of the technology allows the customers to enhance the scope of coverage needed to promote additional services and products, the ability of the bot to play Video, Voice and Text equally well in Traditional Telephony Networks (11100s) and OTT web environment (Apps, Websites) via OTT SDK.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### ADVANTAGES OF THE PRESENT DISCLOSURE

The present disclosure provides for an executable multifaceted bot that facilitates a 3-in-one Chat, Audio and Video service integration to provide seamless customer experience.

The present disclosure provides for an executable multifaceted bot that facilitates concurrency of services for chat services working simultaneously with Audio or Video Services.

The present disclosure provides for an executable multifaceted bot that facilitates upgradation or downgradation from one mode to the other based on request by the service provider or customer.

The present disclosure provides for an executable multifaceted bot that facilitates a bot Integrated Telephony IVR System, over Native Dialler and OTT BOTs with Chat—Audio and Video Bot capability.

The present disclosure provides for an executable multifaceted bot that facilitates any or a combination of Video, Voice and Text BOT Integration with In-bound or Out-bound Telephony IVR System.

The present disclosure provides for an executable multifaceted bot that facilitates Integrated User authentication to provide secure access to personalized information.

The present disclosure provides for an executable multifaceted bot that facilitates Unified Customer Conversation history across all mediums including OTT, IVR and Web.

The present disclosure provides for an executable multifaceted bot that facilitates multilingual capabilities with on-the-fly language change option.

The present disclosure provides for an executable multifaceted bot that facilitates SDK for OTT integration.

The present disclosure provides for an executable multifaceted bot that facilitates seamless experience for a call placed via native dialler.

The present disclosure provides for an executable multifaceted bot that facilitates one platform for all modalities (video, voice, text), simplifies implementation and lowers cost.

The present disclosure provides for an executable multifaceted bot that facilitates Face Recognition and Sentiment Recognition integration.

We claim:

1. A system for generating an executable multi-faceted bot of an entity, said system comprising a processor that executes a set of executable instructions that are stored in a memory, upon which execution, the processor causes the system to:
receive, by a bot maker engine, a first set of data packets corresponding to a user query of said user, and receive, from a database coupled to a server, a knowledgebase comprising a set of expressions associated with one or more potential intents corresponding to said user queries;
extract, by a bot maker engine, a set of attributes corresponding to form of the user query, wherein the form of the user query is selected from any or a combination of a textual form, an audio form, and a video form;
process, through an ML engine, training data comprising the user query, one or more responses corresponding to the user query, and said one or more potential intents that are mapped to each of said user queries, and wherein said ML engine identifies a primary potential intent among said one or more potential intents for said user query by calculating probability for each potential intent among said one or more potential intents for said set of expressions associated with said user query to generate a trained model;
predict, using the ML engine, said one or more responses in any or a combination of said textual form, said audio form, and video form based on the extracted set of attributes and the generated trained model; and
convert, using the ML engine, said one or more responses to any or a combination of textual form, audio form, and video form from any or a combination of textual form, said audio form, and said video form based on any user and system requirement.

2. The system as claimed in claim 1, wherein the database coupled to the server is configured to store said users, bots, user queries, video forms, audio forms and textual messages associated with predefined topic with a time stamp.

3. The system as claimed in claim 1, wherein said bot maker engine extracts from the server a second set of data packets to initialize said multi-faceted bot, wherein said second set of data packets pertains to information comprising of said one or more potential intents, one or more video forms, and a set of trending queries.

4. The system as claimed in claim 1, wherein a user is identified, verified and then authorized to access the system.

5. The system as claimed in claim 4, wherein said one or more responses are initiated once an authorized user generates said user query, and wherein the one or more responses corresponding to said user query that is mapped with the one or more potential intents is transmitted in real-time in the form of a third set of data packets to said user computing device from server side of the multi-faceted bot.

6. The system as claimed in claim 2, wherein the ML engine is configured to enable said user to switch to any said textual, said audio form and said video form from a current form to initiate said user query.

7. The system as claimed in claim 2, wherein the ML engine is configured to enable said user to switch to any said textual, said audio form and said video form from a current form of response provided by the system.

8. The system as claimed in claim 2, wherein said client side of the multi-faceted bot is represented in the form of any or a combination of an animated character, a personality character, or an actual representation of the entity character.

9. The system as claimed in claim 1, wherein said responses pertaining to said audio form and said video form are manually recorded using a recording device, and wherein said responses pertaining to said textual form, said audio form and said video form are stored in the database coupled to said server.

10. The system as claimed in claim 1, wherein the ML engine pre-processes the knowledgebase through a prediction engine for any or a combination of data cleansing, data correction, synonym formation, proper noun extraction, white space removal, stemming of words, punctuation removal, feature extraction, and special character removal, wherein the data pertains to the set of potential queries associated with the entity and corresponding any or a combination of textual form, audio form and video form responses.

11. The system as claimed in claim 1, wherein the ML model comprises a long term short term memory (LSTM) based model having culmination of logistic regression model and neural network based bi-directional LSTM cells.

12. The system as claimed in claim 11, wherein the knowledgebase is used to train LSTM neural net using categorical cross entropy as loss function and an optimizer, wherein the ML model facilitates supervised learning.

13. The system as claimed in claim 12, wherein each layer of the LSTM neural net extracts information during the training to minimize loss function and to retrain one or more weights of the respective layer.

14. The system as claimed in claim 13, wherein the lowest layer of the LSTM neural net is passed to logistic regression (LR) to create sentence vectors from the set of potential queries, said sentence vectors acting as input for the LR to calculate probabilities for each intent mapped to a potential query such that the system estimates an output including the intent with highest probability.

15. The system as claimed in claim 1, wherein the ML engine is configured with an L1L2 engine coupled to said knowledgebase to create variations of a word in the training set to increase the vocabulary of the trained model, wherein said L1L2 engine is configured for a user query generated in audio form.

16. The system as claimed in claim 10, wherein during evaluation of the output, assessment is performed by the prediction engine based on a predetermined set of rules that screen through any or a combination of a pre-defined salutation and one or more attributes associated with the user query such that if the assessment indicates a negative response, the user query is converted into a mathematical representation of expressions using the trained model to identify a relevant intent associated with the user query for providing the output, wherein said prediction is done to estimate the predicted intent with highest probability in a manner that the any or a combination of textual, audio and video response that is mapped with the predicted intent is transmitted.

17. The system as claimed in claim 1, wherein the ML engine is configured with language processing engines to receive said user query in any language and provide said response corresponding to said user query in any language.

18. The system as claimed in claim 1, wherein an authoring portal engine coupled to said ML engine is configured to manage any or a combination of information associated with said users, a plurality of trained models, life cycle of each trained model of said plurality of trained models, sorting and searching said plurality of trained models, life cycle of a plurality of multi-faceted bots and generating executable instructions to invoke said multi-faceted bot among plurality of multi-faceted bots.

19. The system as claimed in claim 18, wherein management of the life cycle of said trained model by the authoring portal engine comprises creating a model, adding expressions and one or more potential intents to said model, training said model, testing said model and publishing said model.

20. The system as claimed in claim 1, wherein said ML engine is configured with an event streaming module, wherein the event streaming module is configured to maintain a queue of expressions, containing information about predictions performed by the ML engine.

21. A method for generating an executable multi-faceted bot of an entity, said method comprising:
receiving, by a bot maker engine, a first set of data packets corresponding to a user query of said user, and receive, from a database coupled to a server, a knowledgebase comprising a set of expressions associated with one or more potential intents corresponding to said user queries;
extracting, by a bot maker engine, a set of attributes corresponding to form of the user query, wherein the form of the user query is selected from any or a combination of a textual form, an audio form, and a video form;
processing, through an ML engine, training data comprising the user query, one or more responses corresponding to the user query, and said one or more potential intents that are mapped to each of said user queries, and wherein said ML engine identifies a primary potential intent among said one or more potential intents for said user query by calculating probability for each potential intent among said one or more potential intents for said set of expressions associated with said user query to generate a trained model;
predicting, using the ML engine, said one or more responses in any or combination of said textual form, said audio form, and video form based on the extracted set of attributes and the generated trained model; and
converting, using the ML engine, said one or more responses to any or a combination of textual form, audio form, and video form fro any or a combination of textual form, said audio form, and said video form based on any user and system requirement.

22. The method as claimed in claim 21, wherein said bot maker engine extracts from the server a second set of data packets to initialize said multi-faceted bot, wherein said second set of data packets pertains to information comprising of said one or more potential intents, one or more video forms, and a set of trending queries.

23. The method as claimed in claim 21, wherein the ML engine is configured to enable said user to switch to any said textual, said audio form and said video form from a current form to initiate said user query.

24. The method as claimed in claim 21, wherein the ML engine is configured to enable said user to switch to any said textual, said audio form and said video form from a current form of response provided by the method.

25. The method as claimed in claim 21, wherein said client side of the multi-faceted bot is represented in the form of any or a combination of an animated character, a personality character, or an actual representation of the entity character.

26. The method as claimed in claim 21, wherein said responses pertaining to said audio form and said video form are manually recorded using a recording device, and wherein said responses pertaining to said textual form, said audio form and said video form are stored in the database coupled to said server.

27. The method as claimed in claim 21, wherein the ML engine pre-processes the knowledgebase through a prediction engine for any or a combination of data cleansing, data correction, synonym formation, proper noun extraction, white space removal, stemming of words, punctuation removal, feature extraction, and special character removal, wherein the data pertains to the set of potential queries associated with the entity and corresponding any or a combination of textual form, audio form and video form responses.

28. The method as claimed in claim 21, wherein the ML model comprises a long term short term memory (LSTM) based model having culmination of logistic regression model and neural network based bi-directional LSTM cells.

29. The method as claimed in claim 28, wherein the knowledgebase is used to train LSTM neural net using categorical cross entropy as loss function and an optimizer, wherein the ML model facilitates supervised learning.

30. The method as claimed in claim 29, wherein each layer of the LSTM neural net extracts information during the training to minimize loss function and to retrain one or more weights of the respective layer.

31. The method as claimed in claim 30, wherein the lowest layer of the LSTM neural net is passed to logistic regression (LR) to create sentence vectors from the set of potential queries, said sentence vectors acting as input for the LR to calculate probabilities for each intent mapped to a potential query such that the method estimates an output including the intent with highest probability.

32. The method as claimed in claim 31, wherein the ML engine is configured with an L1L2 engine coupled to said knowledgebase to create variations of a word in the training set to increase the vocabulary of the trained model, wherein said L1L2 engine is configured for a user query generated in audio form.

33. The method as claimed in claim 27, wherein during evaluation of the output, assessment is performed by the prediction engine based on a predetermined set of rules that screen through any or a combination of a pre-defined salutation and one or more attributes associated with the user query such that if the assessment indicates a negative response, the user query is converted into a mathematical representation of expressions using the trained model to identify a relevant intent associated with the user query for providing the output, wherein said prediction is done to estimate the predicted intent with highest probability in a manner that the any or a combination of textual, audio and video response that is mapped with the predicted intent is transmitted.

34. The method as claimed in claim 21, wherein the ML engine is configured with language processing engines to receive said user query in any language and provide said response corresponding to said user query in any language.

35. The method as claimed in claim 21, wherein an authoring portal engine coupled to said ML engine is configured to manage any or a combination of information associated with said users, a plurality of trained models, life cycle of each trained model of said plurality of trained models, sorting and searching said plurality of trained models, life cycle of a plurality of multi-faceted bots and generating executable instructions to invoke said multi-faceted bot among plurality of multi-faceted bots.

36. The method as claimed in claim 35, wherein management of the life cycle of said trained model by the authoring portal engine comprises creating a model, adding expressions and one or more potential intents to said model, training said model, testing said model and publishing said model.

37. The method as claimed in claim 27, wherein said ML engine is configured with an event streaming module, wherein said event streaming module is configured to maintain a queue of expressions, containing information about predictions performed by the ML engine.
